(19) United States
(12) Patent Application Publication
(10) Pub. No.: US 2026/0014994 A1
(43) Pub. Date: Jan. 15, 2026

(54) APPARATUS

(71) Applicant: TOYOTA JIDOSHA KABUSHIKI KAISHA, Toyota-shi (JP)

(72) Inventors: Kento IWAHORI, Nagoya-shi (JP); Daiki YOKOYAMA, Miyoshi-shi (JP); Rei NAMMIYO, Aichi-gun (JP); Yasuhiro SAITO, Toyoake-shi (JP)

(73) Assignee: TOYOTA JIDOSHA KABUSHIKI KAISHA, Toyota-shi (JP)

(21) Appl. No.: 19/213,486

(22) Filed: May 20, 2025

(30) Foreign Application Priority Data
Jul. 10, 2024 (JP) 2024-110725

(51) Int. Cl. B60W 50/00; B60W 60/00

(52) U.S. Cl. CPC B60W 50/0097; B60W 60/001; B60W 2420/403; B60W 2554/80; B60W 2756/00

(57) ABSTRACT

The apparatus comprises an acquiring unit configured to acquire environmental information regarding at least one of environment around a current location of a moving object, and environment ahead of the moving object in a travel direction, the moving object being capable of moving by unmanned driving; and a generating unit configured to generate value data using the acquired environmental information, the value data including at least one of a braking control value, a braking correction value, a work control value, a work setting value, and a work correction value.

### CROSS REFERENCE TO RELATED APPLICATIONS

The present application claims priority based on a Japanese patent application, application number 2024-110725, filed Jul. 10, 2024, the entire disclosure of which is incorporated herein by reference.

### BACKGROUND

### Field

The present disclosure relates to an apparatus.

### Related Art

Japanese Translation of PCT International Application Publication No. JP2017-538619 discloses a technique for causing vehicles to run autonomously or by remote control during vehicle production steps.

A technique is known in which a moving object, such as a vehicle, is conveyed by unmanned driving in a work place where an operation is performed on the moving object. In such a work place, it may be desirable to stop the moving object at a predetermined position in order to appropriately perform the operation on the moving object. However, in an environment where the actual stop position of the moving object may deviate from the expected stop position, it may not be possible to appropriately stop the moving object at the predetermined position, resulting in a possibility that the operation may not be properly performed.

### SUMMARY

The present disclosure may be implemented by the following aspects.

(1) According to a first aspect of the present disclosure, an apparatus is provided. An apparatus comprising: an acquiring unit configured to acquire environmental information regarding at least one of environment around a current location of a moving object, and environment ahead of the moving object in a travel direction, the moving object being capable of moving by unmanned driving; and a generating unit configured to generate value data using the acquired environmental information, the value data including at least one of a braking control value, a braking correction value, a work control value, a work setting value, and a work correction value, the braking control value being a control value regarding braking of the moving object, the braking correction value being a correction value to correct the braking control value, the work control value being a control value for controlling a work device performing an operation on the moving object, the work setting value being a setting value of the work device, the work correction value being a correction value to correct the work control value. According to this aspect, even in an environment where the actual stop position of the moving object may deviate from the assumed stop position, it is possible to enhance the likelihood that work for the moving object is appropriately performed by controlling at least one of the braking of the moving object and the work performed by the work device using the generated value data.

(2) In the above-described embodiment, the environmental information may include an image in which the environment ahead of the moving object is captured. According to this aspect, since the value data is generated by considering the environment ahead in the travel direction of the moving object, the likelihood that the operation is properly performed can be further enhanced.

(3) In the above-described embodiment, the generating unit may acquire, from the image, a feature regarding at least one of brightness of the image, presence or absence of a predetermined object in the image, and a proportion of the image occupied by the predetermined object, and the generating unit may generate the value data using the acquired at least one feature. According to this aspect, it is possible to generate more appropriate value data using the image as the environmental information effectively.

(4) In the above-described embodiment, the environmental information may include three-dimensional point cloud information of the environment ahead of the moving object. According to this aspect, since the value data is generated with consideration of the environment ahead of the moving object, the likelihood that the operation is properly performed can be further enhanced.

(5) In the above-described embodiment, the generating unit may acquire, from the three-dimensional point cloud information, a feature regarding at least one of a number of points in a point cloud, density of the point cloud, and detection distance of the point cloud, and the generating unit may generate the value data using the acquired at least one feature. According to this aspect, more appropriate value data can be effectively generated using the three-dimensional point cloud information as the environmental information.

The present disclosure can be realized by various aspects other than the apparatus described above. For example, the present disclosure may be embodied in aspects of a system, a server, a control method of a moving object, a program for realizing the control method, a program product including the program, non-transitory storage mediums storing the program, and the like. The program product may be provided, for example, as a non-transitory recording medium on which the program is recorded, or as intangible software deliverable via a network.

### BRIEF DESCRIPTION OF THE DRAWINGS

FIG. 1 is a conceptual diagram showing the configuration of a system in the first embodiment;

FIG. 2 is a block diagram showing a configuration of a system in the first embodiment;

FIG. 3 is a flow chart showing the process of the travel control of the vehicle according to the first embodiment;

FIG. 4 is a flow chart of the stop process in the first embodiment;

FIG. 5 is a diagram for explaining an example of a stop process in the first embodiment;

FIG. 6 is a block diagram showing a configuration of a system in the second embodiment;

FIG. 7 is a flow chart of the stop process in the second embodiment;

FIG. 8 is a diagram for explaining an example of a stop process in the second embodiment;

FIG. 9 is a block diagram showing a configuration of a system in the third embodiment;

FIG. 10 is a flow chart of the stop process in the third embodiment;

FIG. 11 is a diagram for explaining an example of a stop process in the third embodiment;

FIG. 12 is a block diagram showing a configuration of a system in the fourth embodiment;

FIG. 13 is a flow chart of the stop process in the fourth embodiment;

FIG. 14 is a diagram for explaining an example of a stop process in the fourth embodiment;

FIG. 15 is a block diagram showing a configuration of a system in the fifth embodiment;

FIG. 16 is a flow chart of the stop process in the fifth embodiment;

FIG. 17 is a diagram for explaining an example of a stop process in the fifth embodiment;

FIG. 18 is a block diagram of a system in a sixth embodiment;

FIG. 19 is a flow chart showing the process of the travel control of the vehicle according to the sixth embodiment.

### DETAILED DESCRIPTION

### A. First Embodiment

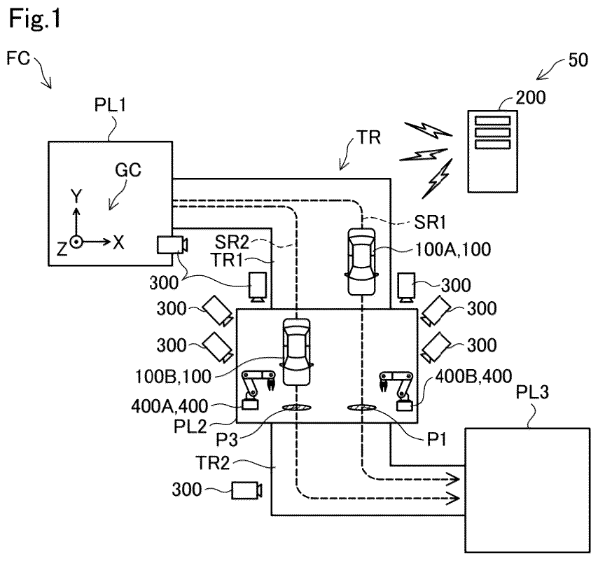

FIG. 1 is a conceptual diagram showing the configuration of a system 50 in the first embodiment. The system 50 comprises one or more vehicle 100 as a moving object, a server 200, one or more external sensor 300, and one or more work device 400. The server 200 in the first embodiment corresponds to the “apparatus” in the present disclosure.

In the present disclosure, the “moving object” means an object capable of moving, and is a vehicle or an electric vertical takeoff and landing aircraft (so-called flying-automobile), for example. The vehicle may be a vehicle to run with a wheel or may be a vehicle to run with a continuous track, and may be a passenger car, a truck, a bus, a two-wheel vehicle, a four-wheel vehicle, a combat vehicle, or a construction vehicle, for example. The vehicle includes a battery electric vehicle (BEV), a gasoline automobile, a hybrid automobile, and a fuel cell automobile. When the moving object is other than a vehicle, the term “vehicle” or “car” in the present disclosure is replaceable with a “moving object” as appropriate, and the term “run” is replaceable with “move” as appropriate.

The vehicle 100 is configured to be capable of running by unmanned driving. The “unmanned driving” means driving independent of running operation by a passenger. The running operation means operation relating to at least one of “run,” “turn,” and “stop” of the vehicle 100. The unmanned driving is realized by automatic remote control or manual remote control using a device provided outside the vehicle 100 or by autonomous control by the vehicle 100. A passenger not involved in running operation may be on-board a vehicle running by the unmanned driving. The passenger not involved in running operation includes a person simply sitting in a seat of the vehicle 100 and a person doing work such as assembly, inspection, or operation of switches different from running operation while on-board the vehicle 100. Driving by running operation by a passenger may also be called “manned driving.”

In the present specification, the “remote control” includes “complete remote control” by which all motions of the vehicle 100 are completely determined from outside the vehicle 100, and “partial remote control” by which some of the motions of the vehicle 100 are determined from outside the vehicle 100. The “autonomous control” includes “complete autonomous control” by which the vehicle 100 controls a motion of the vehicle 100 autonomously without receiving any information from a device outside the vehicle 100, and “partial autonomous control” by which the vehicle 100 controls a motion of the vehicle 100 autonomously using information received from a device outside the vehicle 100.

In the present embodiment, the system 50 is used in a factory FC that manufactures the vehicle 100. the reference coordinate system of the factory FC is a global coordinate system GC and a location in the factory can be expressed by X, Y, and Z coordinates in the global coordinate system GC. The factory FC corresponds to the working area for performing operations on the vehicle 100. The work area is provided with one or more work places. In each work place, various operations are executed. The operations may include, for example, assembling a component with the vehicle 100, inspecting, transporting, repairing, and shipping the vehicle 100. Transportation and shipping of the vehicle 100 may be performed by, for example, unmanned driving, or by using a conveyance device such as a conveyor or an automated guided vehicle. The work place may be, for example, a parking spot for transport or shipment. Each operation may be performed by the work device 400 or by the operator. In order for an operation at a work place to be appropriately performed, it is preferable that the vehicle 100 be appropriately stopped at a target stop position at the work place. The target stop position may include various stop positions, such as a stop position on a conveyor provided in the transport device, a working position by the work device 400, the working position by the operator, or a parking position in the parking area, for example. The stop position on the conveyor may be, for example, a position of irregularities provided on the conveyor, the irregularities being configured to support the wheels of the vehicle 100.

The factory FC comprises a first place PL1, a second place PL2, and the third place PL3. Each place from the first place PL1 to the third place PL3 corresponds to a work place. The first place PL1 is the work place for assembling the vehicle 100. The second place PL2 and the third place PL3 are work places for inspecting the vehicle 100. The places from the first place PL1 to the third place PL3 are connected to each other by a track TR on which the vehicle 100 can travel. More specifically, the first place PL1 and the second place PL2 are connected by a track TR1. The second place PL2 and the third place PL3 are connected by a track TR2. The factory FC has a plurality of external sensors 300 installed along the track TR. In the present embodiment, at least one of the plurality of external sensors 300 is disposed in the vicinity of the second place PL2. The position of the external sensor 300 in the factory FC is pre-adjusted. The vehicle 100 moves from the first place PL1 to the third place PL3 through the track TR by unmanned driving. In the present embodiment, the vehicle 100 travels in the second place PL2 by unmanned driving. The vehicle 100 runs across the second place PL2 from the side of the track TR1 toward the side of the track TR2. In other embodiments, the vehicle 100 may run by unmanned driving across the first place PL1 or across the third place PL3.

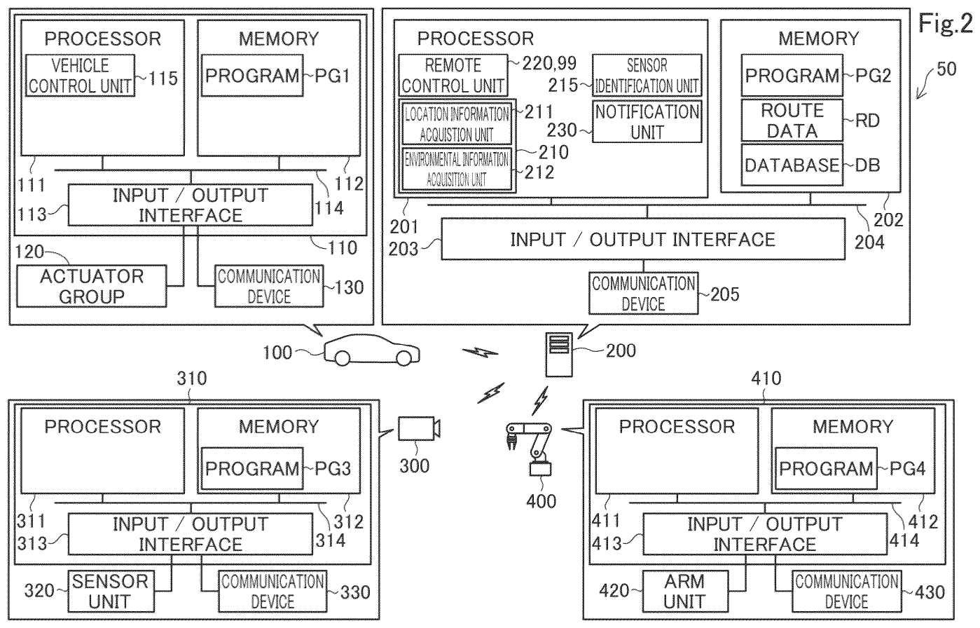

FIG. 2 is a block diagram showing a configuration of a system 50 in the first embodiment. The vehicle 100 includes a vehicle controller 110 for controlling the various portions of the vehicle 100, an actuator group 120 including one or more actuators driven under the control of the vehicle controller 110, and a communication device 130 for wireless communication with external devices such as the server 200. The actuator group 120 includes an actuator of a driving device for accelerating the vehicle 100, an actuator of a steering device for changing a travel direction of the vehicle 100, and an actuator of a braking device for decelerating the vehicle 100.

The vehicle controller 110 is constituted by a computer including a processor 111, a memory 112, an input/output interface 113, and an internal bus 114. The processor 111, the memory 112, and the input/output interface 113 are connected via the internal bus 114 to communicate bidirectionally. The actuator group 120 and the communication device 130 are Connected to the input/output interface 113. The processor 111 implements various functions, including functions as the vehicle control unit 115, by executing a program PG1 stored in the memory 112.

The vehicle control unit 115 causes the vehicle 100 to run by controlling the actuator group 120. The vehicle control unit 115 is able to cause the vehicle 100 to run by controlling the actuator group 120 using the running control signal received from the server 200. The running control signal is a control signal for running the vehicle 100. In the present embodiment, the running control signal includes an acceleration and a steering angle of the vehicle 100 as parameters. In other embodiments, the running control signal may include the speed of the vehicle 100 as a parameter instead of or in addition to the acceleration of the vehicle 100.

The external sensor 300 is a sensor located outside the vehicle 100. The external sensor 300 in the present embodiment is configured to capture the vehicle 100 and the external environment of the vehicle 100 from outside the vehicle 100. The external sensor 300 includes a control device 310, a sensor unit 320, and a communication device 330. The control device 310 controls various parts of the external sensor 300. In particular, the control device 310 captures the vehicle 100 and the external environment by controlling the sensor unit 320. The communication device 330 can communicate with other devices, such as the server 200, by wired or wireless communication.

The control device 310 is configured with a computer including a processor 311, a memory 312, an input/output interface 313, and an internal bus 314. The processor 311, the memory 312, and the input/output interface 313 are connected via the internal bus 314 to communicate bidirectionally. The sensor unit 320 and the communication device 330 are Connected to the input/output interface 313. The processor 311 implements various functions such as a function of controlling the sensor unit 320 by executing a program PG3 previously stored in the memory 312. The communication device 330 can communicate with other devices, such as the server 200, by wired or wireless communication.

In the present embodiment, the external sensor 300 is configured with a ranging device. The ranging device as the external sensor 300 measures the vehicle 100 and the external environment. The ranging device outputs three-dimensional point cloud information as a detection result. A camera or a LIDAR (Light Detection And Ranging) device can be used as the ranging device. In particular, the LiDAR device is preferred because high-precision three-dimensional point cloud information can be acquired. The external sensor 300 in the present embodiment is configured with the LiDAR device. The sensor unit 320 has an optical system for emitting and receiving a laser beam for ranging. The optical system of the sensor unit 320, for example, emits and receives pulsed lasers in the near infrared region. In the present embodiment, the position of each external sensor 300 is fixed, and the relationship between the global coordinate system GC and the device coordinate system of each external sensor 300 is known. The coordinate transformation matrices for transforming between the coordinate values of the global coordinate system GC and the coordinate values of the device coordinate system of each external sensor 300 are stored in advance in the server 200.

The server 200 is configured with a computer including a processor 201, a memory 202, an input/output interface 203 and an internal bus 204. The processor 201, the memory 202, and the input/output interface 203 are connected to be able to communicate in both directions via the internal bus 204. The input/output interface 203 is connected to the communication device 205 for communication with various devices outside the server 200.

The communication device 205 may communicate with the vehicle 100 via wireless communication and may communicate with the external sensor 300 via wired or wireless communication. The processor 201 implements various functions including functions as an acquisition unit 210, a sensor identification unit 215, a remote control unit 220, and an notification unit 230 by executing a program PG2 stored in the memory 202. In addition to program PG2, the memory 202 stores route data RD and a database DB.

The route data RD represents the standard route on which the vehicle 100 runs. In the route data RD, a standard route is defined for each type of the vehicle 100. Here, the “type of the vehicle 100” may be, for example, a vehicle type, a model code of the vehicle 100, a body type, a color, or an individual vehicle 100. In the route data RD, the identification number and the standard route are associated with each other so that the standard route of the vehicle 100 can be identified, for example, by referring to the route data RD using the identification number of the vehicle 100. In the present embodiment, in the route data RD, the first standard route SR1 is associated with the first type of vehicle 100A, and the second standard route SR2 is associated with the second type of vehicle 100B. A reference route, which will be described below, is determined based on the standard routes such as the first standard route SR1 and the second standard route SR2.

In the present embodiment, the acquisition unit 210 includes a location information acquisition unit 211, and an environmental information acquisition unit 212.

The location information acquisition unit 211 acquires the location of the vehicle 100. In the present embodiment, the location information acquisition unit 211 acquires the location of the vehicle 100 by acquiring the detection result by the sensor and by acquiring the vehicle location information using the detection result. The vehicle position will be described later.

The environmental information acquisition unit 212 acquires environmental information. The environmental information is information about the external environment. The external environment includes at least one of the environment around the current location of the vehicle 100 and environment ahead of the vehicle 100. Environmental information, more specifically, is information acquired by capturing at least one of the environment around the present location and the environment ahead of the vehicle 100.

“The environment ahead of the vehicle 100” means the environment ahead of the vehicle 100 in a travel direction of the vehicle 100. The environment ahead of the vehicle 100 corresponds to the external environment around a point where the vehicle 100 is scheduled to run later.

In the present embodiment, the environmental information is three-dimensional point cloud information of the environment ahead of the vehicle 100. “Three-dimensional point cloud information of the environment ahead of the vehicle 100” is information in which the environment ahead of the vehicle 100 is captured as a three-dimensional point cloud. The three-dimensional point cloud information in which the external environment is captured is also referred to as “environmental point cloud information”. Specifically, the three-dimensional point cloud information in which the environment ahead of the vehicle 100 is captured is also called “forward point cloud information”. The environmental point cloud information is acquired by using the ranging device as the external sensor 300. The environmental point cloud information includes, for example, point clouds representing the road surface of the track on which the vehicle 100 runs, point clouds representing an object on the road surface, and the like.

The sensor identification unit 215 identifies one or more external sensor 300 as a target external sensor 300 using the location of the vehicle 100 acquired by the location information acquisition unit 211. The target external sensor 300 refers to the external sensor 300 used by the acquisition unit 210 to acquire environmental information. More specifically, the sensor identification unit 215 identifies, as the target external sensor 300, the external sensor 300 that is positionally capable of acquiring forward point cloud information, based on the vehicle location information and the route data RD. The above-mentioned environmental information acquisition unit 212 acquires environmental information from the target external sensor 300 identified by the sensor identification unit 215.

The remote control unit 220 generates a control command to cause the vehicle 100 to run by unmanned driving using vehicle location information. The remote control unit 220 causes the vehicle 100 to run by remote control by transmitting the control command to the vehicle 100. In the present embodiment, the remote control unit 220 generates the above-described running control signal as the control command.

In the present embodiment, the remote control unit 220 functions as a generating unit 99. The generating unit 99 generates value data using the acquired environmental information. The value data is used to correct at least one of a stop position of the vehicle 100 and a working position of the work device 400 in accordance with the environmental information.

The value data includes at least one of a braking-related value and a work-related value. The braking-related value is a value related to the control of braking of the vehicle 100. The braking-related value includes at least one of a braking control value and a braking correction value. The braking control value is a control value related to braking the vehicle 100. The braking control value includes, for example, at least one of an indication value related to braking the vehicle 100 and a value for generating the indication value. The braking correction value is a correction value to correct the braking control value. The work-related value is a value relating to the operation performed by the work device 400. The working-related value includes at least one of a work control value, a work setting value and a work correction value. The work control value is a control value for controlling the work device 400. The work setting value is a setting value of the work device 400. The work setting value may specify, for example, a default position of the arm unit 420 or a normal movement trajectory of the arm unit 420. The work setting value may be a correction value for correcting the set value. The work correction value is a correction value to correct the work control value.

The value data in the present embodiment includes the braking control value and the braking correction value as the braking-related values. In the present embodiment, the braking control value determines the magnitude of the braking force per unit time. More specifically, the braking control value is generated as an indication value to specify a negative acceleration in the running control signal. First, the generating unit 99 generates the braking correction value using environmental information. Next, the generating unit 99 generates the braking control value by correcting the braking control value using the braking correction value, which has been generated using the environmental information. The braking control value has been generated in advance without using the environmental information. In the present embodiment, the generating unit 99 acquires features of the environmental point cloud information and generates the value data using the acquired features. The features of the environmental point cloud information preferably include at least one of the number of points in a point cloud, the point cloud density, and the detection distance of the point cloud. The detection distance of the point cloud represents a limit value of a distance at which the point cloud can be detected. For example, the detection distance of the point cloud in the environmental point cloud information is defined as the distance to the point cloud having the smallest strength among the point clouds included in the environmental point cloud information. In the present embodiment, the generating unit 99 acquires the number of points as the feature of the environmental point cloud information.

In the present embodiment, the generating unit 99 generates value data such that the braking force per unit time becomes larger when the acquired number of points is the first point cloud number compared to when the acquired number of points is the second point cloud number. The second point cloud number is a number of points in a point cloud greater than the first point cloud number. More specifically, the generating unit 99 generates a braking correction value by referring to the database DB based on the acquired number of points and corrects the control command using the generated braking correction value. In the present embodiment, the database DB stores the number of points and the braking correction value associated with the number of points. Furthermore, in the database DB, a braking correction value for increasing the braking force per unit time is associated with a smaller number of points.

Here, the laser light emitted from the sensor unit 320 of the external sensor 300 is more likely to be diffusely reflected in the atmosphere during bad weather such as rain, snow, fog, or yellow sand compared to good weather. As a result, during bad weather, the number of points, point cloud density, and detection distance in the acquired 3D point cloud information tend to decrease compared to good weather. Therefore, when the number of points is the first point cloud number, the probability that the external environment is bad weather is higher compared to when the number of points is the second point cloud number. During such bad weather, foreign substances such as water droplets, snow, ice, or yellow sand may adhere to the track on which the vehicle 100 travels, potentially worsening the road surface conditions. These foreign substances, such as water droplets, snow, ice, or yellow sand, contribute to the reduction of friction between the wheels of the vehicle 100 and the road surface, thereby hindering the braking of the vehicle 100. Additionally, during bad weather, due to foreign substances in the atmosphere, the number of points and point cloud density may decrease, potentially reducing the accuracy of vehicle location information. During bad weather, due to the worsening of road surface conditions and the decrease in accuracy of vehicle location information, there is a high probability that the actual stop position of the vehicle 100 will deviate from the expected stop position. In particular, due to foreign substances hindering the braking of the vehicle 100, the actual stop position of the vehicle 100 tends to deviate forward in the travel direction compared to the expected stop position.

The notification unit 230 informs the user of various information regarding the system 50. The notification unit 230 uses, for example, an alarm device provided in the vehicle 100 or a notification device configured to communicate with the server 200 and the vehicle 100 to inform information. The notification device may be, for example, a display device for displaying visual information, a speaker for outputting audio information, or a mobile terminal owned by the user. The user is, for example, a worker or manager at the factory FC.

The work device 400 includes a control device 410, an arm unit 420, and a communication device 430. The control device 410 controls each part of the work device 400. The arm unit 420 is configured with a vertically articulated robot arm. An end effector for performing an operation is mounted on the tip of the arm unit 420. In the present embodiment, the end effector is configured to clamp various items such as a tool, a part, and an inspection equipment. The communication device 430 can communicate with other devices such as the server 200 via wired or wireless communication. The arm unit 420 is not limited to a vertically articulated robot arm and may be composed of, for example, a horizontally articulated robot arm, an orthogonal robot arm, or a parallel link robot arm. The end effector may be configured to adsorb parts instead of clamping them.

The control device 410 is composed of a computer equipped with a processor 411, a memory 412, an input/output interface 413, and an internal bus 414. The processor 411, memory 412, and input/output interface 413 are connected via the internal bus 414 to enable bidirectional communication. The arm unit 420 and the communication device 430 are connected to the input/output interface 413. In the present embodiment, the processor 411 realizes various functions such as controlling the arm unit 420 by executing the program PG4 stored in advance in the memory 412.

FIG. 1 shows examples of the work device 400, specifically work devices 400A and 400B. The work device 400A is a work device 400 for performing an operation on the vehicle 100A stopped at position P1. The position P1 is located on the first standard route SR1 in the second place PL2. The position P1 corresponds to the target stop position of the vehicle 100A and the working position of the work device 400A in the second place PL2. The work device 400B is a work device 400 for performing an operation on the vehicle 100B stopped at position P3. The position P3 is located on the second standard route SR2 in the second place PL2. The position P3 corresponds to the target stop position of the vehicle 100B and the working position of the work device 400B in the second place PL2.

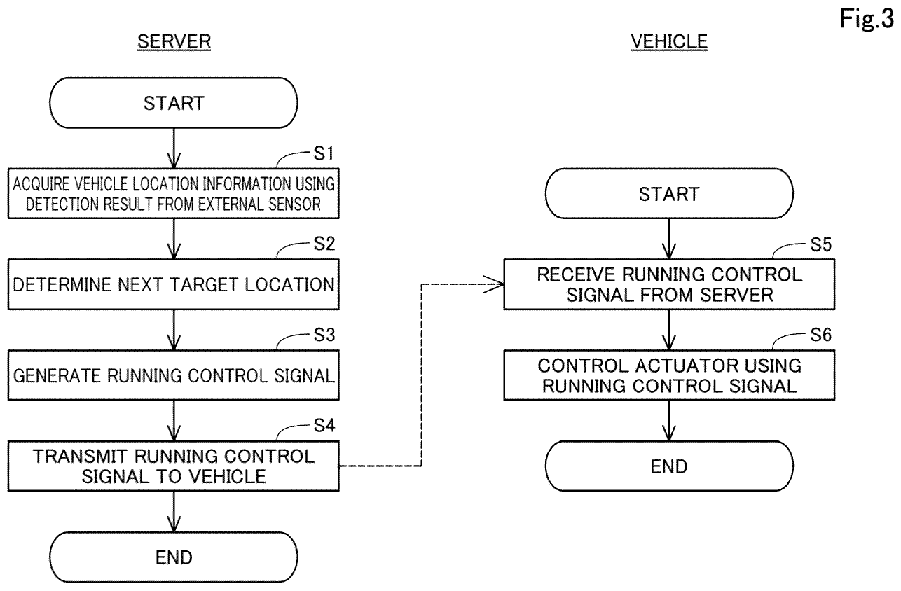

FIG. 3 is a flowchart showing a processing procedure for running control of the vehicle 100 in the first embodiment. In the processing procedure of FIG. 3, the processor 201 of the server 200 functions as an acquisition unit 210 and a remote control unit 220 by executing the program PG2. Additionally, the processor 111 of the vehicle 100 functions as a vehicle control unit 115 by executing the program PG1.

In step S1, the processor 201 of the server 200 acquires vehicle location information using the detection result output from the external sensor 300. The vehicle location information is locational information as a basis for generating a running control signal. In the present embodiment, the vehicle location information includes the location and orientation of the vehicle 100 in the global coordinate system GC of the factory FC. Specifically, in step S1, the processor 201 acquires the vehicle location information using the captured image acquired from the camera as the external sensor 300.

More specifically, in step S1, the processor 201 acquires, for example, vehicle location information by template matching using 3D point cloud data as the detection result and pre-prepared reference point cloud data. Various algorithms such as ICP (Iterative Closest Point) and NDT (Normal Distributions Transform) are used as template matching algorithms.

In step S2, the processor 201 of the server 200 determines a target location to which the vehicle 100 is to move next. In the present embodiment, the target location is expressed by X, Y, and Z coordinates in the global coordinate system GC. The memory 202 of the server 200 contains a reference route RR stored in advance as a route along which the vehicle 100 is to run. The route is expressed by a node indicating a departure place, a node indicating a way point, a node indicating a destination, and a link connecting nodes to each other. The processor 201 determines the target location to which the vehicle 100 is to move next using the vehicle location information and the reference route RR. The processor 201 determines the target location on the reference route RR ahead of a current location of the vehicle 100.

In step S3, the processor 201 of the server 200 generates a running control signal for causing the vehicle 100 to run toward the determined target location. The processor 201 calculates a running speed of the vehicle 100 from transition of the location of the vehicle 100 and makes comparison between the calculated running speed and a target speed of the vehicle 100 determined in advance. If the running speed is lower than the target speed, the processor 201 generally determines an acceleration in such a manner as to accelerate the vehicle 100. If the running speed is higher than the target speed as, the processor 201 generally determines an acceleration in such a manner as to decelerate the vehicle 100. If the vehicle 100 is on the reference route RR, the processor 201 determines a steering angle and an acceleration in such a manner as to prevent the vehicle 100 from deviating from the reference route RR. If the vehicle 100 is not on the reference route RR, in other words, if the vehicle 100 deviates from the reference route RR, the processor 201 determines a steering angle and an acceleration in such a manner as to return the vehicle 100 to the reference route RR.

In step S4, the processor 201 of the server 200 transmits the generated running control signal to the vehicle 100. The processor 201 repeats the acquisition of vehicle location information, the determination of a target location, the generation of a running control signal, the transmission of the running control signal, and others in a predetermined cycle.

In step S5, the processor 111 of the vehicle 100 receives the running control signal transmitted from the server 200. In step S6, the processor 111 of the vehicle 100 controls the actuator group 120 of the vehicle 100 using the received running control signal, thereby causing the vehicle 100 to run at the acceleration and the steering angle indicated by the running control signal. The processor 111 repeats the reception of a running control signal and the control over the actuator group 120 in a predetermined cycle. According to the system 50 in the present embodiment, it becomes possible to move the vehicle 100 without using a transport unit such as a crane or a conveyor.

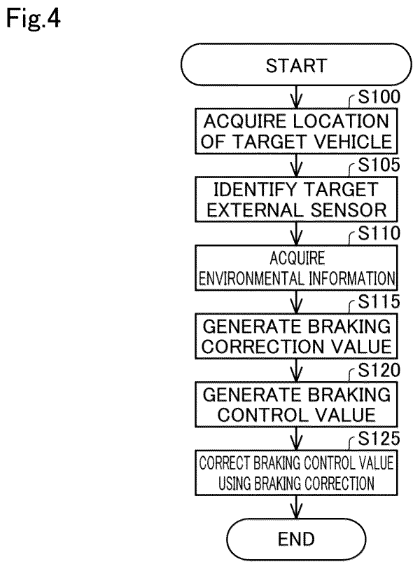

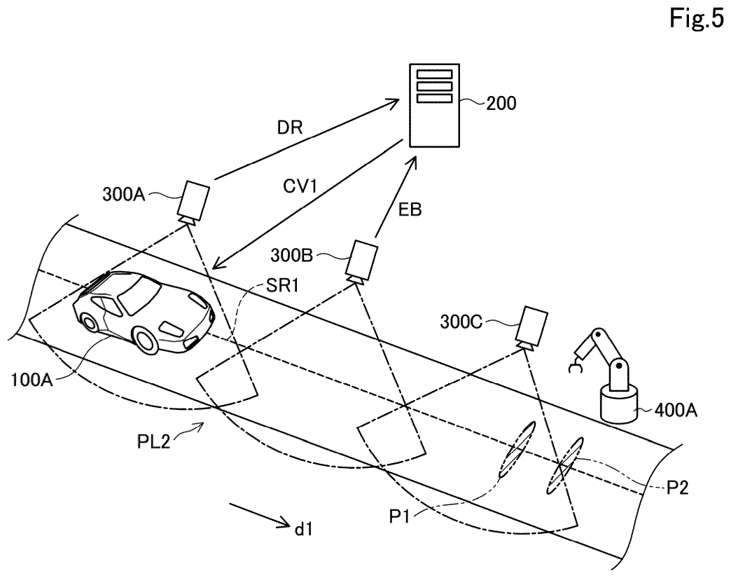

FIG. 4 is a flowchart of the stop process in the present embodiment. FIG. 5 is a diagram explaining an example of the stop process in the present embodiment. The stop process is executed to stop the vehicle 100 at the target stop position in the work location and perform work during the processing procedure of FIG. 3. The stop process is initiated, for example, when the vehicle 100 reaches a position before the work location or a predetermined position within the work location. In the present embodiment, the stop process is executed by the processor 201. FIG. 5 shows an example of the stop process executed to stop the vehicle 100A at position P1 within the second place PL2. That is, in the example of FIG. 5, the vehicle 100 subject to the stop process (target vehicle) is the vehicle 100A. In FIG. 5, the detectable range of each external sensor 300 is schematically indicated by a dashed line. FIG. 5 also shows the travel direction d1 of the vehicle 100A traveling along the first standard route SR1. The travel direction d1 is the direction with the track TR2 side shown in FIG. 1 as the front and the track TR1 side as the rear.

In step S100 of FIG. 4, the location information acquisition unit 211 acquires the location of the target vehicle 100. Specifically, the location information acquisition unit 211 acquires vehicle location information of the target vehicle 100. In the example of FIG. 5, vehicle location information is acquired using the detection result DR of the external sensor 300A. The external sensor 300A is an external sensor 300 capable of capturing the vehicle 100A at the start of step S100.

In step S105 of FIG. 4, the sensor identification unit 215 identifies the target external sensor 300 using the vehicle location information acquired in step S100 and the route data RD. In the example of FIG. 5, the external sensor 300B is identified as the target external sensor 300. The external sensor 300B corresponds to the first standard route SR1 and is an external sensor 300 located in front of the vehicle 100 in the travel direction d1 at the start of step S105. The external sensor 300B is an external sensor 300 capable of detecting the external environment on the rear side of position P1 in the first standard route SR1.

In step S105, multiple external sensors 300 may be identified as the target external sensor 300, or a single external sensor 300 may be identified as the target external sensor 300. When a single external sensor 300 is identified as the target external sensor 300, for example, among multiple external sensors 300 located in front of the vehicle 100, the external sensor 300 closer to the vehicle 100 may be identified, or the external sensor 300 closer to the position P1, which is the target stop position, may be identified. For example, in FIG. 5, in addition to or instead of the external sensor 300B, the external sensor 300C closer to the position P1 may be identified. More specifically, the external sensor 300C is an external sensor 300 capable of capturing the external environment including position P1. By identifying the external sensor 300 closer to the target stop position in this way, it becomes easier to reflect the external environment near the target stop position in the value data.

In step S110 of FIG. 4, the environmental information acquisition unit 212 acquires environmental information from the target external sensor 300 identified in step S105. In the example of FIG. 5, environmental information EB is acquired from the external sensor 300B.

In step S115 of FIG. 4, the generating unit 99 generates a braking correction value using the environmental information acquired in step S110. More specifically, the generating unit 99 acquires the number of points as a feature from the forward point cloud information acquired in step S110 and generates the braking correction value by referencing the database DB based on the acquired number of points.

If multiple external sensors 300 are identified in step S105, environmental information may be acquired from each identified external sensor 300 in step S110. In this case, in step S115, features may be acquired from each piece of environmental information, and the value data may be generated using each acquired feature. For example, in the present embodiment, the generating unit 99 may acquire the number of points from each acquired environmental information and generate the value data by referencing the database DB based on a statistic derived from the acquired numbers of points. More specifically, the generating unit 99 may reference the database DB based on the average value of each number of points. As the statistic, for example, a weighted average may be used. In this case, by giving more weight to the features of the environmental information acquired by the external sensor 300 closer to the target stop position, it is possible to reflect the external environment near the vehicle 100 in the value data while making it easier to reflect the external environment near the target stop position in the value data.

In step S120, the remote control unit 220 generates a braking control value using the vehicle location information acquired in step S105. Specifically, in step S120, the remote control unit 220 generates a running control signal that includes the braking control value.

In step S125, the generating unit 99 corrects the braking control value included in the running control signal generated in step S120 using the braking correction value generated in step S115. Then, the generating unit 99 transmits the running control signal, which includes the corrected braking control value, to the vehicle 100. The vehicle 100 brakes by controlling the actuator group 120 using the braking control value included in the received running control signal. In the example of FIG. 5, the running control signal CV1 is transmitted to the vehicle 100A. The running control signal CV1 is a running control signal that includes the corrected braking correction value.

According to the server 200 in the present embodiment as described above, value data including the braking-related value is generated using the environmental information of the vehicle 100. Therefore, even in an environment where the actual stop position of the vehicle 100 may deviate from the expected stop position, the vehicle 100 can be braked to appropriately stop at the expected stop position using the braking-related value. More specifically, for example, in the example of FIG. 5, if a foreign object that hinders braking occurs at the second place PL2, the actual braking distance of the vehicle 100 may become longer than the expected braking distance. As a result, if the braking control value generated in step S120 is used without modification, that is, if the braking control value that does not depend on environmental information is used to stop the vehicle 100 at position P1, the actual stop position of the vehicle 100 may shift to position P2, which is behind position P1 in the travel direction d1. In contrast, in the present embodiment, by braking the vehicle 100 using value data that reflects environmental information, it is possible to suppress the deviation between the actual stop position and the expected stop position of the vehicle 100. As a result, the likelihood of appropriately performing the operation on the vehicle 100 can be increased.

In the present embodiment, the environmental information is forward point cloud information. As a result, since the value data is generated with consideration of the environment ahead of the vehicle 100, the likelihood of appropriately performing the operation on the vehicle 100 can be further increased.

In the present embodiment, value data is generated using the number of points as a feature of the environmental point cloud information. Therefore, more appropriate value data can be generated by using the environmental point cloud information more effectively. In other embodiments, point cloud density may be used as a feature of the environmental point cloud information. The detection distance of the point cloud may be used as a feature of the environmental point cloud information. According to these other embodiments, more appropriate value data can be generated by using the environmental point cloud information more effectively, similar to the present embodiment.

In the present embodiment, the generating unit 99 generates value data such that the braking force per unit time becomes larger when the number of points is the first number of points compared to when the number of points is the second number of points. Therefore, it is possible to suppress the actual stop position of the vehicle 100 from deviating forward in the travel direction from the expected stop position due to bad weather. As a result of generating value data such that the braking force per unit time becomes larger as described above, even if the actual stop position deviates backward in the travel direction from the expected stop position, the vehicle 100 is stopped before the expected stop position, making subsequent handling easier compared to when the actual stop position deviates forward in the travel direction from the expected stop position. Thus, in the present embodiment, even in bad weather, the likelihood that the operation on the vehicle 100 will be performed appropriately can be increased.

In the present embodiment, the location information acquisition unit 211 for acquiring the position of the vehicle 100 is provided, and the environmental information acquisition unit 212 identifies the target external sensor 300 using the position acquired by the location information acquisition unit 211 during the stop process and acquires environmental information only from the identified target external sensor 300. Therefore, for example, compared to a configuration in which environmental information is acquired from all external sensors 300, the communication load and processing load associated with communication between the server 200 and the external sensors 300 can be reduced.

In other embodiments, the generating unit 99 may generate value data such that the braking force per unit time becomes larger when the point cloud density as a feature of the environmental point cloud information is the first point cloud density compared to when the point cloud density is the second point cloud density. The second point cloud density is a point cloud density larger than the first point cloud density. In other embodiments, the generating unit 99 may generate value data such that the braking force per unit time becomes larger when the detection distance as a feature of the environmental point cloud information is the first detection distance compared to when the detection distance is the second detection distance. The second detection distance is a detection distance longer than the first detection distance. According to these other embodiments, it is possible to suppress the actual stop position of the vehicle 100 from deviating forward in the travel direction from the expected stop position due to bad weather, similar to the present embodiment.

In other embodiments, the braking control value that determines the magnitude of the braking force per unit time may be, for example, an instruction value indicating the vehicle speed or an instruction value directly indicating the braking force per unit time.

In other embodiments, the braking control value may be a control value that determines the braking start timing of the vehicle 100. The braking start timing is the timing at which the braking of the vehicle 100 is started. The braking start timing may be expressed as the point in time when braking is started or as the distance from the expected stop position. The control value that determines the braking start timing may be, for example, a control value that determines the timing at which a negative magnitude of acceleration for braking first occurs. In this case, the braking timing becomes later because a positive or zero acceleration is specified at the timing when a negative acceleration would normally be specified by the braking control value. Conversely, the braking timing becomes earlier because a negative acceleration is specified at a timing when a negative acceleration would not normally be specified by the braking control value. In this case, the generating unit 99 may generate value data such that the braking start timing becomes earlier, instead of or in addition to generating value data such that the braking force per unit time becomes larger as described above. More specifically, the generating unit 99 may generate value data such that the braking start timing becomes earlier in at least one of the cases where the number of points is the first number of points, the point cloud density is the first point cloud density, and the detection distance is the first detection distance. In this case, in the database DB, a braking correction value for determining an earlier braking start timing may be associated with a smaller number of points, a smaller point cloud density, or a shorter detection distance. According to this configuration, it is possible to suppress the actual stop position of the vehicle 100 from deviating forward in the travel direction from the expected stop position due to bad weather. The control value that determines the braking start timing of the vehicle 100 may be, for example, an instruction value indicating the vehicle speed or an instruction value directly indicating the braking start timing of the vehicle 100.

### B. Second Embodiment

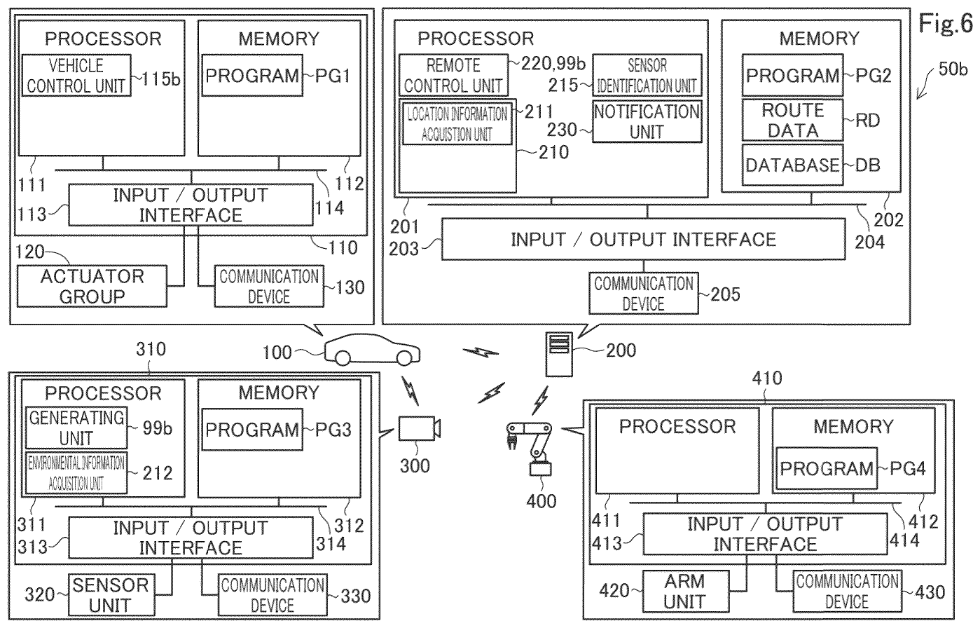

FIG. 6 is a block diagram showing the configuration of the system 50b in the second embodiment. Unlike the first embodiment, in the second embodiment, the control device 310 of the external sensor 300 includes a generating unit 99b. The control device 310 in the second embodiment corresponds to the “apparatus” in the present disclosure. For aspects of the system 50b in the second embodiment that are not specifically described, they are the same as in the first embodiment.

In the present embodiment, the processor 311 of the control device 310 functions as the generating unit 99b and the environmental information acquisition unit 212 by executing the program PG3 stored in the memory 312. The generating unit 99b generates a braking correction value in the same manner as in the first embodiment. On the other hand, unlike the first embodiment, the generating unit 99b does not generate a braking control value. In the present embodiment, the acquisition unit 210 of the server 200 does not function as the environmental information acquisition unit 212. In the present embodiment, the vehicle control unit 115b of the vehicle 100 is configured to be capable of correcting the braking control value.

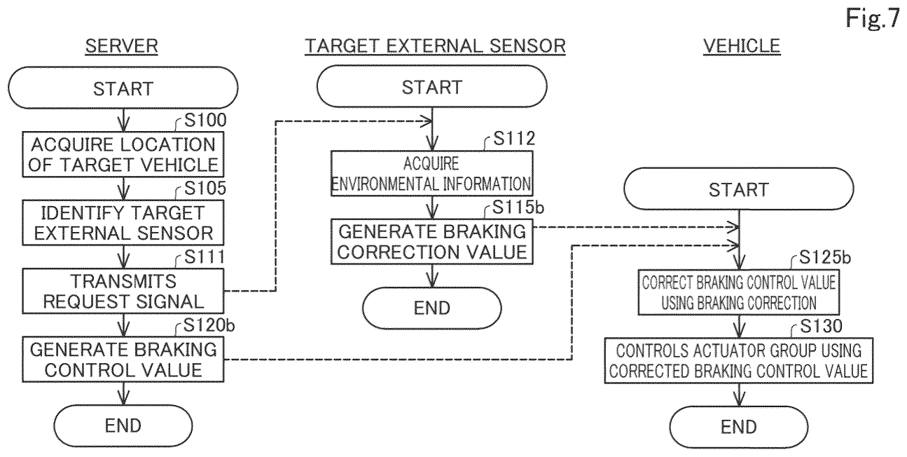

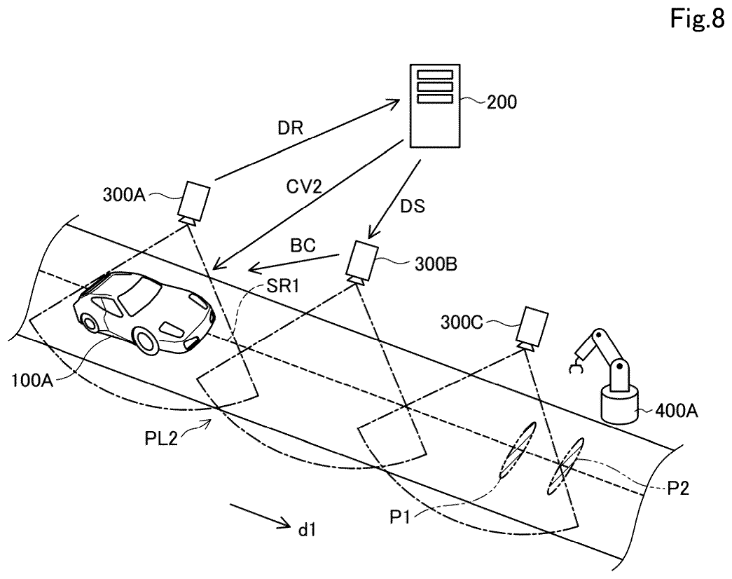

FIG. 7 is a flowchart of the stop process in the second embodiment. FIG. 8 is a diagram illustrating an example of the stop process in the second embodiment. In FIG. 8, as in FIG. 5, an example of the stop process executed for the vehicle 100A is shown. In FIG. 7, the steps similar to those in FIG. 4 are denoted by the same reference numerals as in FIG. 4. In step S111 of FIG. 7, the sensor identification unit 215 sends a request signal to the external sensor 300 identified in step S105. The request signal is a signal requesting the generation of value data to the generating unit 99b. In the example of FIG. 8, the request signal DS is sent to the external sensor 300B.

In step S112, the environmental information acquisition unit 212 of the external sensor 300 that received the request signal acquires environmental information.

In step S115b, the generating unit 99b of the control device 310 generates a braking correction value using the environmental information acquired in step S112, in a manner substantially similar to step S115 of FIG. 3. Subsequently, as shown in FIG. 8, the generating unit 99b sends the generated braking correction value BC to the vehicle 100. In other embodiments, step S112 may not be executed after receiving the request signal. For example, if environmental information is acquired at predetermined time intervals and a request signal is received, the generating unit 99b may generate a braking correction value using the most recently acquired environmental information in step S115b.

In step S120b of FIG. 7, the remote control unit 220 generates a running control signal including a braking control value, similar to step S120 of FIG. 4. Subsequently, unlike step S120 of FIG. 4, the remote control unit 220 sends the generated running control signal to the target vehicle 100. In the example of FIG. 8, the running control signal CV2 is sent to the vehicle 100A. The running control signal CV2, unlike the running control signal CV1 shown in FIG. 5, includes a braking control value that does not depend on the environmental information.

In step S125b of FIG. 7, the vehicle control unit 115b of the target vehicle 100 corrects the braking correction value included in the running control signal generated in step S120 using the braking correction value generated in step S115b. In the example of FIG. 8, the braking control value included in the running control signal CV2 is corrected using the braking correction value BC. In step S130, the vehicle control unit 115b brakes the vehicle 100 by controlling the actuator group 120 using the braking control value corrected in step S125b.

According to the control device 310 described in the second embodiment, as in the first embodiment, value data including braking-related values is generated using the environmental information of the vehicle 100. Therefore, even in an environment where the actual stop position of the vehicle 100 may deviate from the expected stop position, the likelihood of appropriately performing the operation on the vehicle 100 can be increased.

In other embodiments, for example, the external sensor 300 may send environmental information to the vehicle 100, and the vehicle control unit 115b of the vehicle controller 110 provided in the vehicle 100 may generate a braking correction value using the environmental information. In this form, the vehicle controller 110 corresponds to the “apparatus” in the present disclosure. That is, in this case, the vehicle controller 110 includes at least the environmental information acquisition unit and the generating unit.

### C. Third Embodiment

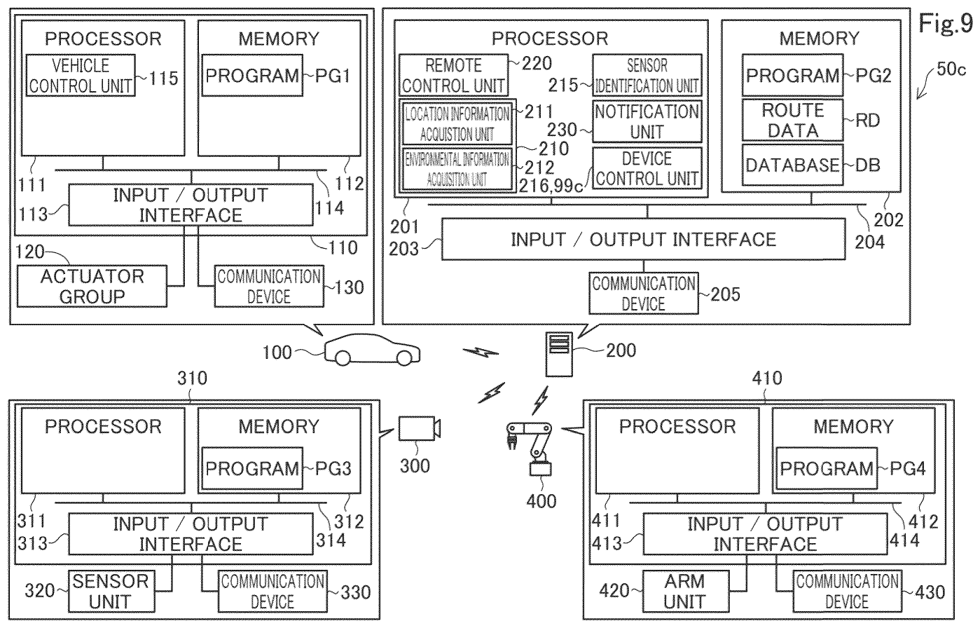

FIG. 9 is a block diagram showing the configuration of the system 50c in the third embodiment. Unlike the first embodiment, in the third embodiment, the value data does not include the braking-related value but includes the work-related value. As for the points not specifically described in the system 50c of the third embodiment, they are the same as in the first embodiment.

In the present embodiment, the processor 201 functions as each functional unit described in the first embodiment, in addition to functioning as the device control unit 216. However, in the present embodiment, the remote control unit 220 does not function as the generating unit 99, and the device control unit 216 functions as the generating unit 99c.

The device control unit 216 identifies the target work device 400 and controls the target work device 400 by sending a work command for an operation to the target work device 400. The target work device 400 is a work device responsible for the operation on the target vehicle 100. In the present embodiment, the device control unit 216 identifies the work device 400 using the location of the vehicle 100 acquired by the location information acquisition unit 211. More specifically, the sensor identification unit 215 identifies the target work device 400 using the vehicle location information of the target vehicle 100 and the route data RD. The work command includes a work control value.

In the present embodiment, the value data generated by the generating unit 99c includes the work-related value. More specifically, the value data includes a work control value as a work-related value. In the present embodiment, the work control value is a parameter related to at least one of the position and movement of the arm unit 420 of the work device 400.

In the present embodiment, the generating unit 99c generates value data so that the operation by the work device 400 is performed at a position further forward in the travel direction of the vehicle 100 when the number of points acquired as a feature of the environmental point cloud information is the first point cloud number, compared to when the number of points is the second point cloud number. More specifically, the generating unit 99c generates, as value data, for example, a work control value for positioning the arm unit 420 further forward in the travel direction, or a work control value for operating the arm unit 420 further forward in the travel direction.

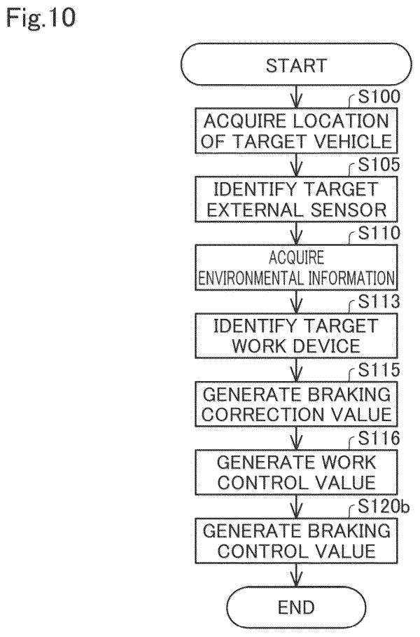

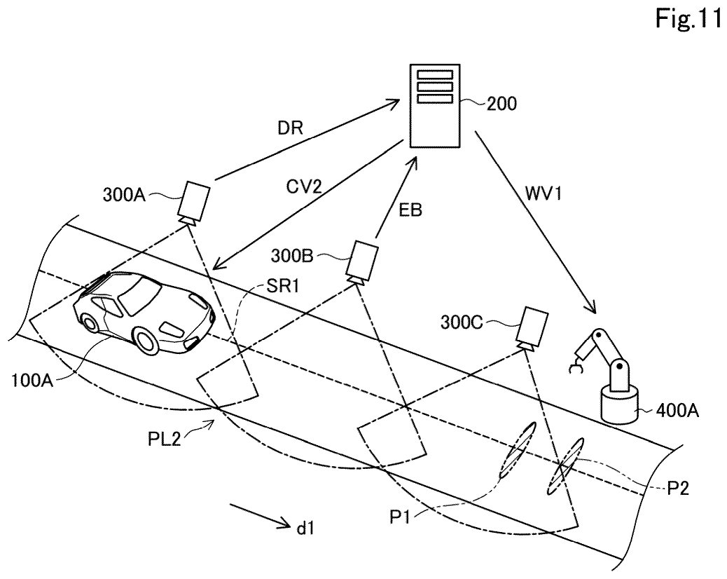

FIG. 10 is a flowchart of the stop process in the third embodiment. FIG. 11 is a diagram illustrating an example of the stop process in the third embodiment. In FIG. 11, as in FIG. 5, an example of the stop process executed for the vehicle 100A is shown. In FIG. 10, the steps similar to those in FIG. 4 and FIG. 7 are denoted by the same reference numerals as in FIG. 4 and FIG. 7.

In step S113 of FIG. 10, the device control unit 216 identifies the target work device 400 using the route data RD and the position of the vehicle 100 acquired in step S100. In the example of FIG. 11, the work device 400A is identified as the target work device 400. The work device 400A corresponds to the first standard route SR1 and is a work device responsible for the operation on the vehicle 100A at the second place PL2. The work device 400A is pre-adjusted to perform the operation on the vehicle 100A with position P1 as the work position. More specifically, the work device 400A is pre-adjusted in terms of the arrangement position, the position of the arm unit 420, and the operation setting values, etc., so that work can be appropriately performed on the vehicle 100A stopped at position P1.

In step S116 of FIG. 10, the generating unit 99c generates a work control value for the target work device 400 identified in step S113 using the environmental information acquired in step S110. Then, the generating unit 99c sends the generated work control value to the target work device 400. In the example of FIG. 11, the work control value WV1 is sent to the work device 400A. The work device 400A performs the operation on the vehicle 100A using the received work control value WV1. Also, the target vehicle 100 is braked by controlling the actuator group 120 using the running control signal CV2 sent from the server 200 in step S120b.

According to the server 200 described in the third embodiment, value data including work-related values is generated using the environmental information of the vehicle 100. Therefore, in an environment where the actual stop position of the vehicle 100 may deviate from the expected stop position, the work position can be corrected according to the deviation of the stop position using the work-related values. More specifically, for example, in the example of FIG. 11, if rain, fog, snow, or yellow sand occurs at the second place PL2, the actual stop position of the vehicle 100 braked using the running control signal CV2 may shift from position P1 to position P2. In the present embodiment, the operation of the work device 400 is controlled using value data reflecting the environmental information, so that the operation on the vehicle 100 can be executed by the work device 400 at a work position corresponding to the shifted stop position of the vehicle 100. As a result, the likelihood of appropriately performing the operation on the vehicle 100 can be increased.

In the present embodiment, the work control value is a parameter related to at least one of the position and movement of the arm unit 420, and the generating unit 99c generates value data so that the operation by the work device 400 is performed at a position further forward in the travel direction of the vehicle 100 when the number of points is the first point cloud number, compared to when the number of points is the second point cloud number. Therefore, even if the actual stop position of the vehicle 100 shifts forward in the travel direction from the expected stop position due to bad weather, the operation can be performed by the work device 400 at a position corresponding to the shifted stop position. It should be noted that as a result of the value data being generated as described above, even if the actual stop position shifts backward in the travel direction from the expected stop position, the vehicle 100 stops before the expected stop position, making subsequent handling easier compared to when the actual stop position shifts forward in the travel direction from the expected stop position. Thus, in the present embodiment, it is possible to enhance the likelihood that operations on vehicle 100 will be conducted appropriately even in adverse weather conditions.

In other embodiments, the generating unit 99c may acquire the point cloud density as a feature of the environmental point cloud information and generate value data so that the operation is conducted further forward in the travel direction when the point cloud density is the first point cloud density compared to when it is the second point cloud density. In other embodiments, the generating unit 99c may acquire the detection distance as a feature of the environmental point cloud information and generate value data so that the operation is conducted further forward in the travel direction when the detection distance is the first detection distance compared to when it is the second detection distance. According to these other embodiments, similar to the third embodiment, operations can be performed by the work device 400 at a work position corresponding to a shifted stop position due to adverse weather.

### D. Fourth Embodiment

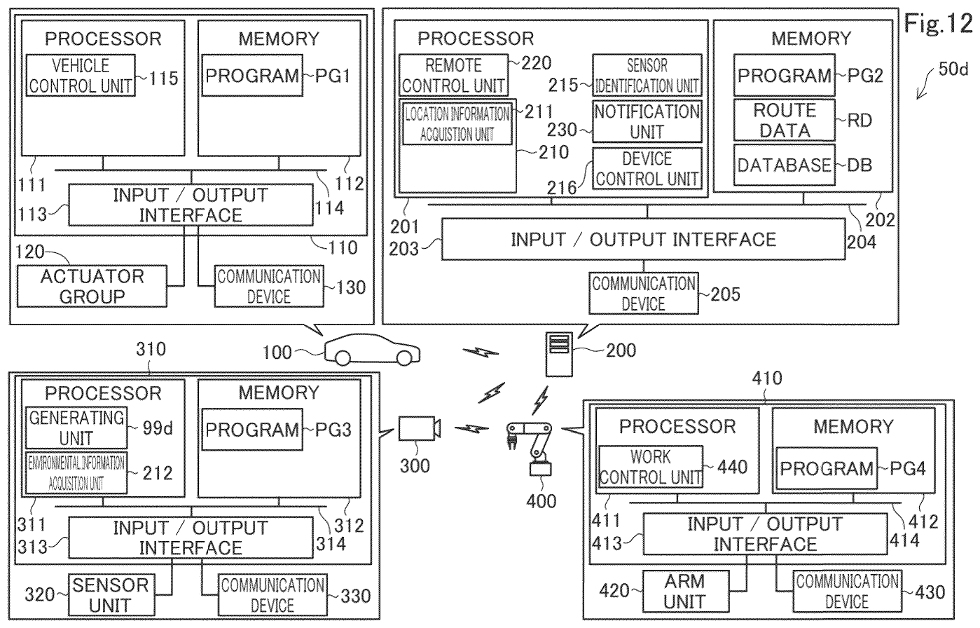

FIG. 12 is a block diagram showing the configuration of system 50d in the fourth embodiment. Unlike the third embodiment, in the fourth embodiment, the control device 310 of the external sensor 300 includes a generating unit 99d. The control device 310 in the fourth embodiment corresponds to the ‘device’ in the present disclosure. As for the aspects of system 50d in the fourth embodiment that are not specifically described, they are the same as in the third embodiment.

In the fourth embodiment, similar to the second embodiment, the control device 310 functions as the generating unit 99d and the environmental information acquisition unit 212 by executing the program PG3 stored in memory 312. In the present embodiment, unlike the third embodiment, the generating unit 99d generates a work correction value instead of a work control value as the work-related value.

In the present embodiment, the processor 201 functions as the device control unit 216, similar to the third embodiment. However, in the present embodiment, the device control unit 216 does not function as the generating unit 99c. The acquisition unit 210 of the server 200 does not function as the environmental information acquisition unit 212.

In the present embodiment, the processor 411 of the control device 410 provided in the work device 400 functions as the work control unit 440 by executing the program PG4 stored in memory 412. The work control unit 440 generates a work control value and performs an operation by controlling the arm unit 420 using the generated work control value. In the present embodiment, the work control unit 440 generates a corrected work control value by correcting the work control value, which is independent of the environmental information generated by the device control unit 216 of the server 200, using the work correction value generated by the generating unit 99d.

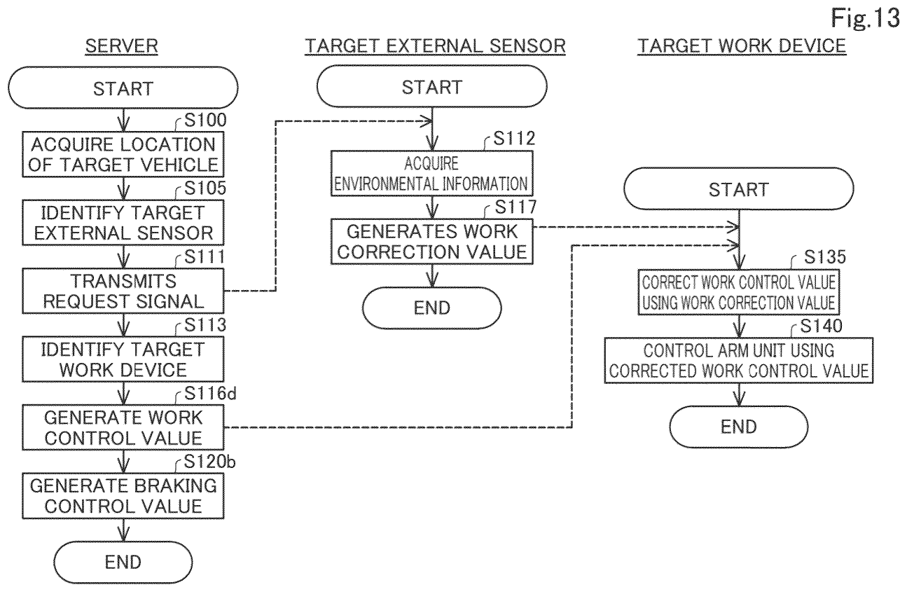

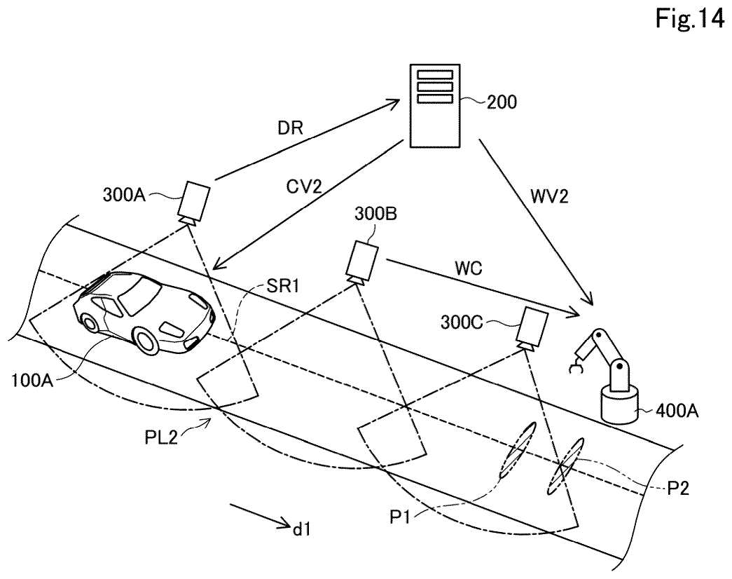

FIG. 13 is a flowchart of the stop process in the fourth embodiment. FIG. 14 is a diagram explaining an example of the stop process in the fourth embodiment. In FIG. 14, similar to FIG. 5, an example of the stop process executed for vehicle 100A is shown. In FIG. 13, steps similar to those in FIG. 4, FIG. 7, and FIG. 10 are denoted by the same reference numerals as in FIG. 4, FIG. 7, and FIG. 10.

In step S116d, the device control unit 216 generates a work control value for the target work device 400 and transmits the generated work control value to the target work device 400. In the example of FIG. 14, the work control value WV2 is transmitted to the work device 400A. The work control value WV2, unlike the work control value WV1 shown in FIG. 11, is a work control value independent of environmental information.

In step S117, the generating unit 99 of the control device 310 generates a work correction value using the environmental information acquired in step S112 and transmits the generated work correction value to the target work device 400. In the example of FIG. 14, the work correction value WC is transmitted to the work device 400A. In the present embodiment, when the work correction value is generated, the external sensors from 300A to 300C corresponding to the first standard route SR1 are configured to transmit the generated work correction value to the work device 400A corresponding to the first standard route SR1, similar to each external sensor.

In step S135 of FIG. 13, the work control unit 440 of the target work device 400 corrects the work control value generated in step S116 using the work correction value generated in step S117. In the example of FIG. 14, the work control value WV2 is corrected by the work correction value WC. In step S140 of FIG. 13, the work control unit 440 performs operations by controlling the arm unit 420 using the corrected work control value generated in step S135.

According to the control device 310 described in the fourth embodiment, similar to the third embodiment, the value data including work-related values is generated using the environmental information of vehicle 100. Therefore, even in an environment where the actual stop position of vehicle 100 may deviate from the expected stop position, the likelihood of appropriately performing the operation on the vehicle 100 can be increased.

In other embodiments, for example, the external sensor 300 may transmit environmental information to the work device 400, and the control device 410 provided in the work device 400 may generate a work correction value using the environmental information. In this form, the control device 410 corresponds to the ‘device’ in the present disclosure. That is, in this case, the control device 410 includes at least the environmental information acquisition unit and the generating unit.

### E. Fifth Embodiment

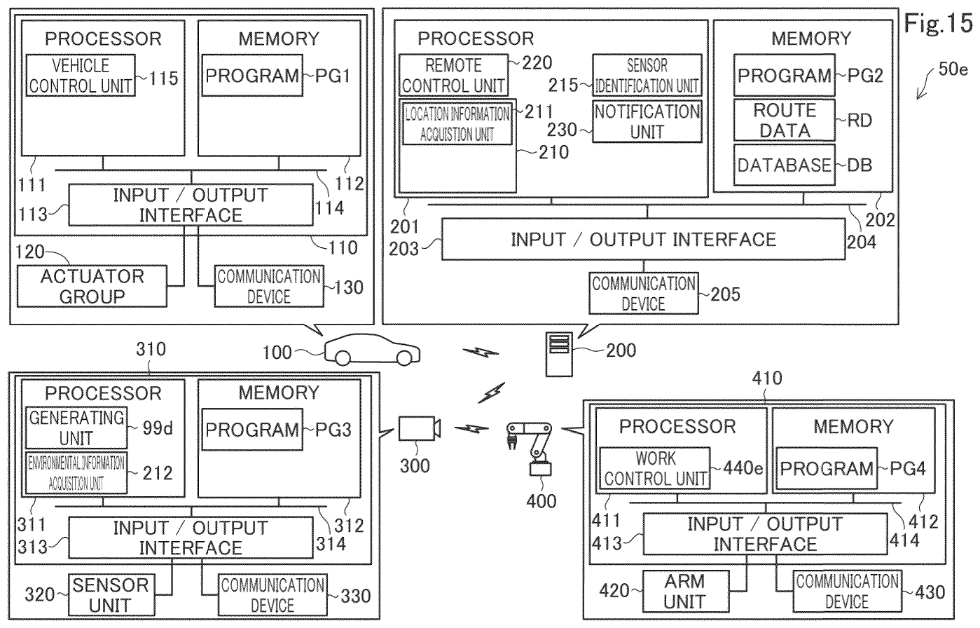

FIG. 15 is a block diagram showing the configuration of system 50e in the fifth embodiment. In the fifth embodiment, unlike the fourth embodiment, the server 200 does not include the device control unit 216 and does not generate work control values for the work device 400. As for the aspects of system 50e in the fifth embodiment that are not specifically described, they are the same as in the fourth embodiment.

In the present embodiment, unlike the fourth embodiment, the work control unit 440e generates a work control value independent of environmental information and generates a corrected work control value by correcting the generated work control value using the work correction value generated by the generating unit 99d.

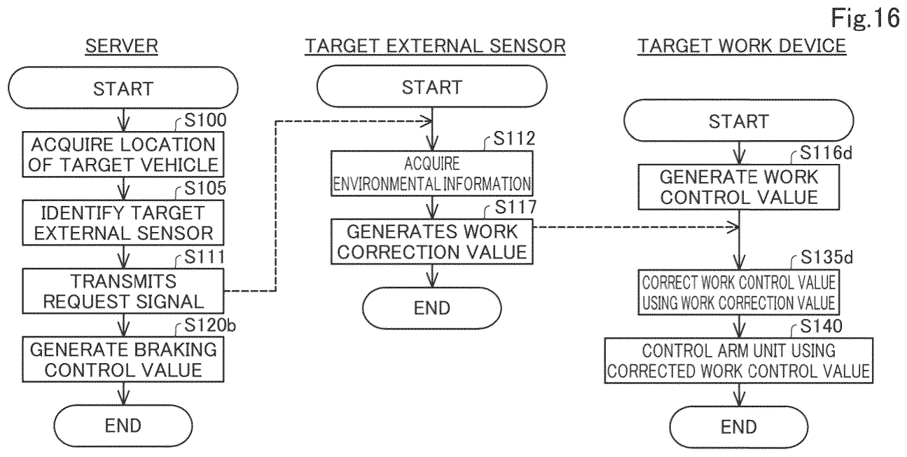

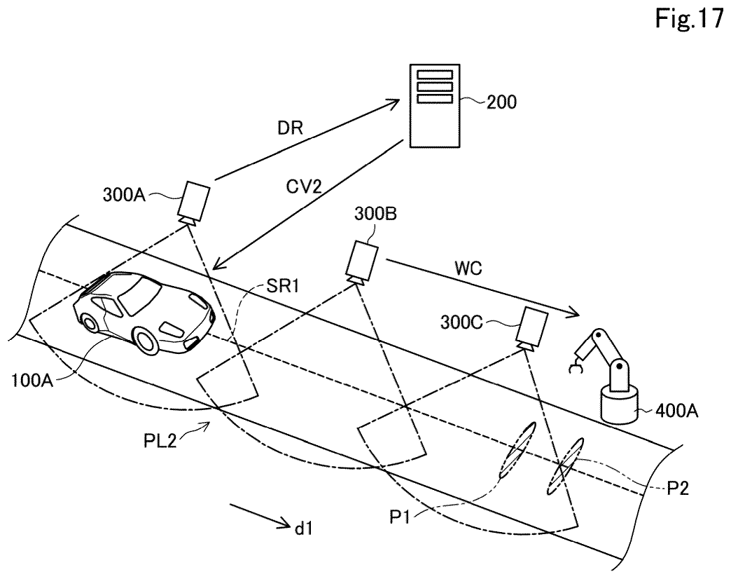

FIG. 16 is a flowchart of the stop process in the fifth embodiment. FIG. 17 is a diagram explaining an example of the stop process in the fifth embodiment.

In step S116d, the work control unit 440e of the target work device 400 generates a work control value. In step S116d, for example, a work control value for performing an operation on vehicle 100A, which has stopped at position P1, is generated using the preset setting value of the work control unit 440e. In step S135d, the work control unit 440 corrects the work control value generated in step S116d using the work correction value received from the target external sensor 300. In the example of FIG. 17, the work control value generated by the work control unit 440 of the work device 400A is corrected using the work correction value WC.

According to the control device 310 described in the fifth embodiment, similar to the third embodiment, the value data including work-related values is generated using the environmental information of vehicle 100. Therefore, even in an environment where the actual stop position of vehicle 100 may deviate from the expected stop position, the likelihood of appropriately performing the operation on the vehicle 100 can be increased.

In other embodiments, the external sensor 300 may transmit environmental information to the work device 400, and the control device 410 provided in the work device 400 may generate a work control value using the environmental information. In this form, the control device 410 corresponds to the ‘device’ in the present disclosure. That is, in this case, the control device 410 includes at least the environmental information acquisition unit and the generating unit.

### F. Sixth Embodiment

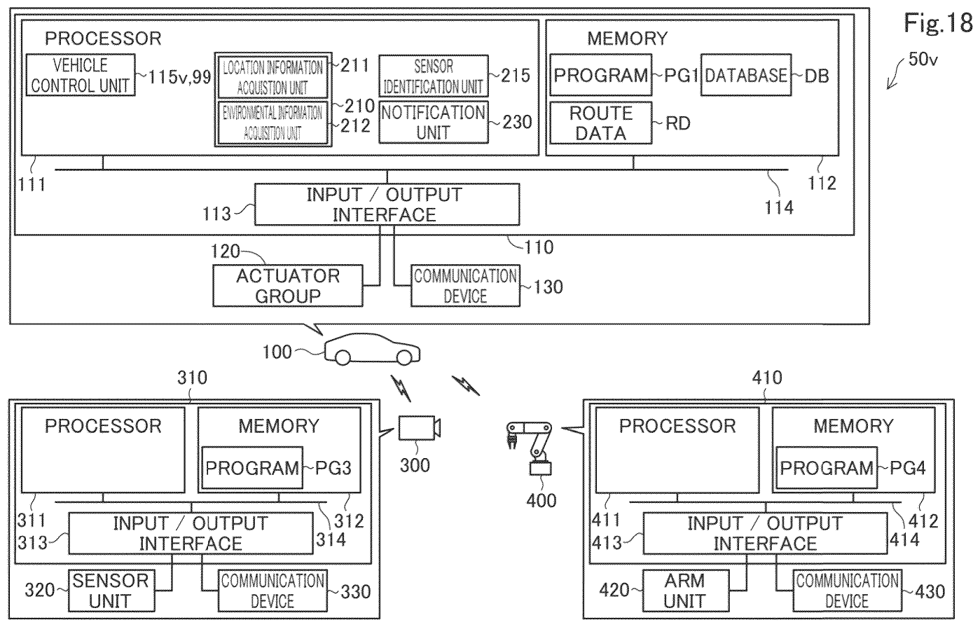

FIG. 18 is a block diagram of system 50v in the sixth embodiment. The system 50v in the present embodiment, unlike the first embodiment, does not include a server 200. Additionally, the vehicle in the present embodiment is capable of running through autonomous control. As for other configurations, unless specifically described, they are the same as in the first embodiment. Since the device configuration of the vehicle in the present embodiment is the same as vehicle 100 in the first embodiment, for convenience, the vehicle in the present embodiment is also referred to as vehicle 100.

In the present embodiment, the communication device 130 of the vehicle 100 can communicate with the external sensor 300 and the work device 400. The processor 111 of the vehicle controller 110 functions as the vehicle control unit 115v, acquisition unit 210, sensor identification unit 215, and notification unit 230 by executing the program PG1 stored in memory 112. The vehicle control unit 115v can cause the vehicle 100 to run under autonomous control by controlling the actuator group 120 using the travel control signal generated by vehicle 100. Additionally, the vehicle control unit 115v functions as the generating unit 99. In the memory 112, in addition to program PG1, route data RD and database DB are stored.

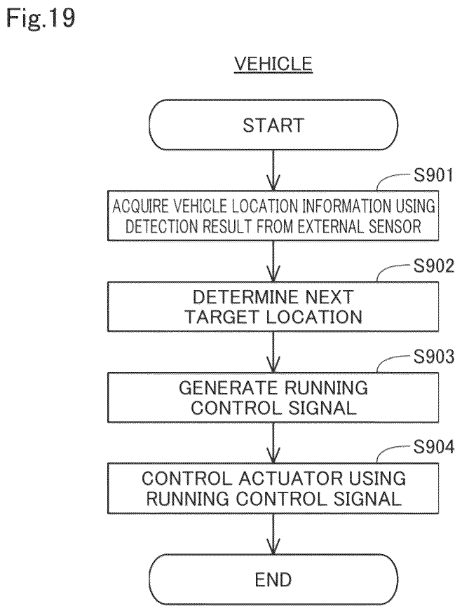

FIG. 19 is a flowchart showing a processing procedure for running control of the vehicle 100 in the second embodiment. In the processing procedure of FIG. 19, the processor 111 of vehicle 100 functions as the acquisition unit 210 and the vehicle control unit 115v by executing program PG1.

In step S901, the processor 111v of the vehicle controller 110v acquires vehicle location information using detection result output from the camera as the external sensor 300. In step S902, the processor 111v determines a target location to which the vehicle 100 is to move next. In step S903, the processor 111v generates a running control signal for causing the vehicle 100 to run to the determined target location. In step S904, the processor 111v controls the actuator group 120 using the generated running control signal, thereby causing the vehicle 100 to run by following a parameter indicated by the running control signal. The processor 111v repeats the acquisition of vehicle location information, the determination of a target location, the generation of a running control signal, and the control over the actuator in a predetermined cycle. According to the system 50v in the present embodiment, it is possible to cause the vehicle 100 to run by autonomous control without controlling the vehicle 100 remotely using the server 200.

In the present embodiment, a stop process similar to FIG. 4 is executed. However, in the present embodiment, the stop process is executed by the processor 111 of the vehicle controller 110, not by the processor 201 of the server 200. Also, in the present embodiment, ‘target vehicle 100’ means the own vehicle.

In the sixth embodiment described above, the vehicle controller 110 also generates value data including braking-related values using the environmental information of the vehicle 100, similar to the first embodiment. Therefore, even in an environment where the actual stop position of the vehicle 100 may deviate from the expected stop position, the likelihood of appropriately performing the operation on the vehicle 100 can be increased.

In other embodiments where the vehicle 100 runs under autonomous control, the stop process may be executed in a manner similar to the second to fifth embodiments. If the stop process is executed in a manner similar to the third or fourth embodiment, the processor 111 of the vehicle controller 110 may function as the device control unit 216. In the form where the vehicle 100 runs under autonomous control, for example, the system 50 may be equipped with a server 200. In this case, the server 200 may include at least part of the functional units of the system 50v, such as at least part of the functional units possessed by the vehicle 100 in the sixth embodiment.

### G. Other Embodiments

(G1) In each of the above embodiments, the external sensor 300 is configured by a ranging device. In contrast, the external sensor 300 may be configured with a camera that images the vehicle 100 or the external environment.

If a camera is used as the external sensor 300, in step S1 of FIG. 3, vehicle location information can be estimated using the captured image as the detection result. More specifically, in step S1 of FIG. 3, the processor 201 for example, determines the outer shape of the vehicle 100 from the captured image, calculates the coordinates of a positioning point of the vehicle 100 in a coordinate system of the captured image, namely, in a local coordinate system, and converts the calculated coordinates to coordinates in the global coordinate system GC, thereby acquiring the location of the vehicle 100. The outer shape of the vehicle 100 in the captured image may be detected by inputting the captured image to a detection model DM using artificial intelligence, for example. The detection model DM is prepared in the system 50 or outside the system 50. The detection model DM is stored in advance in the memory 202 of the server 200, for example. An example of the detection model DM is a learned machine learning model that was learned so as to realize either semantic segmentation or instance segmentation. For example, a convolution neural network (CNN) learned through supervised learning using a learning dataset is applicable as this machine learning model. The learning dataset contains a plurality of training images including the vehicle 100, and a label showing whether each region in the training image is a region indicating the vehicle 100 or a region indicating a subject other than the vehicle 100, for example. In training the CNN, a parameter for the CNN is preferably updated through backpropagation in such a manner as to reduce error between output result obtained by the detection model and the label. The processor 201 can acquire the orientation of the vehicle 100 through estimation based on the direction of a motion vector of the vehicle 100 detected from change in location of a feature point of the vehicle 100 between frames of the captured images using optical flow process, for example.

(G1a) In the embodiment (G1), an image capturing the external environment of the vehicle 100 may be used as the environmental information. In this case, it is preferable that the environmental information is an image capturing the environment ahead of the vehicle 100. In this way, value data is generated with consideration of the environment ahead in the travel direction of the vehicle 100, further increasing the likelihood of performing the operation on the vehicle 100 appropriately. Hereinafter, an image capturing the external environment is also referred to as an “environmental image.” In particular, an image capturing the environment ahead of the vehicle 100 is also referred to as a “forward image.” The environmental image includes, for example, pixels representing the road surface of the track on which the vehicle travels and pixels representing objects on the road surface. The system 50 may be equipped with both a camera and a ranging device as the external sensor 300, and may use both environmental images and environmental point cloud information as environmental information.

(G1b) In the embodiment (G1a), it is preferable that the generating unit 99 acquires at least one feature quantity from the environmental image, such as the brightness of the environmental image, the presence or absence of a predetermined object in the environmental image, and a proportion of the environmental image occupied by the object, and generates value data using the acquired feature quantity. The object is, for example, a foreign substance that hinders braking, such as rain, snow, fog, and yellow sand. The Object in the environmental image may be detected using, for example, a trained model learned to detect objects in input images or a rule-based model defined to detect objects in input images. The “a proportion of the environmental image occupied by the object” is expressed, for example, as a proportion of area or number of pixels. According to this form, more appropriate value data can be generated by using the environmental image more effectively.

(G1c) In the above embodiments (G1a) and (G1b), the generating unit 99 may generate the value data such that the braking force per unit time becomes larger when the brightness of the environmental image is the first brightness compared to when the brightness is the second brightness. The second brightness is higher than the first brightness. The generating unit 99 may generate the value data such that the braking force per unit time becomes larger when the predetermined object is included in the environmental image compared to when the predetermined object is not included. The generating unit 99 may generate value data such that the braking force per unit time becomes larger when a proportion of the environmental image occupied by the object is a first proportion compared to when the proportion is the second proportion. The second proportion is smaller than the first proportion. During adverse weather conditions such as rain, snow, fog, and yellow sand, the predetermined object is more likely to be reflected in the environmental image compared to good weather conditions. As a result, the brightness in the environmental image tends to decrease. Therefore, by generating value data as in the embodiment (G1c), it is possible to suppress the actual stop position of the vehicle 100 from deviating forward in the travel direction from the expected stop position due to adverse weather conditions.

(G1d) In the embodiments from (G1a) to (G1c), the braking control value may be a control value that determines the braking start timing of the vehicle 100. In this case, the generating unit 99 may generate the value data such that the braking start timing becomes earlier in at least one of the cases where the brightness of the environmental image is the first brightness, objects are included in the environmental image, or the proportion of objects in the environmental image is the first proportion. According to this form, it is possible to suppress the actual stop position of the vehicle 100 from deviating forward in the travel direction from the expected stop position due to adverse weather conditions.

(G1e) In the embodiments from (G1a) to (G1d), the value data may include the work-related value. In this case, the generating unit 99 may generate the value data such that the operation by the work device 400 is performed at a position further forward in the travel direction of the vehicle 100 when the brightness of the environmental image is the first brightness compared to when the brightness is the second brightness. The generating unit 99 may generate the value data such that the operation by the work device 400 is performed at a position further forward in the travel direction of the vehicle 100 when the predetermined object is included in the environmental image compared to when the object is not included. The generating unit 99 may generate the value data such that the operation by the work device 400 is performed at a position further forward in the travel direction of the vehicle 100 when the proportion of proportion of the environmental image occupied by the object is the first proportion compared to when the proportion is the second proportion. According to this form, even if the actual stop position of the vehicle 100 deviates forward in the travel direction from the expected stop position due to adverse weather conditions, the operation can be performed by the work device 400 at a position corresponding to the deviated stop position.

(G2) In each of the above embodiments, the acquisition unit 210 may function as a braking distance acquisition unit that acquires a predicted value of braking distance. In this case, the generating unit 99 may the generate value data using the acquired the predicted value of braking distance. In this case, the acquisition unit 210 acquires the braking distance based on, for example, a feature of the environmental image as the environmental information or a feature of the environmental point cloud information as the environmental information. More specifically, the acquisition unit 210 may acquire the braking distance using, for example, a trained model learned to calculate the braking distance using the input environmental information, a rule-based model defined to calculate the braking distance using the input environmental information, or a database associating features of environmental information with braking distance.

(G2a) In the embodiment (G2), the generating unit 99 may generate the value data such that the braking force per unit time becomes larger when the acquired predicted value of braking distance is the first distance compared to when the predicted value is the second distance. The second distance is shorter than the first distance. According to this form, in an environment where the braking distance may become longer, such as during adverse weather conditions, it is possible to suppress the actual stop position of the vehicle 100 from deviating forward in the travel direction from the expected stop position.

(G2b) In the embodiments (G2) and (G2a), the generating unit 99 may generate the value data such that the braking start timing becomes earlier when the acquired predicted value of braking distance is the first distance compared to when the predicted value is the second distance. According to this form, in an environment where the braking distance may become longer, such as during adverse weather conditions, it is possible to suppress the actual stop position of the vehicle 100 from deviating forward in the travel direction from the expected stop position.

(G2c) In the embodiments from (G2) to (G2b), the value data may include work-related values. In this case, the generating unit 99 may generate the value data such that the operation by the work device 400 is performed at a position further forward in the travel direction of the vehicle 100 when the acquired predicted value of braking distance is the first distance compared to when the predicted value is the second distance. According to this form, even if the actual stop position of the vehicle 100 deviates forward in the travel direction from the expected stop position due to adverse weather conditions in an environment where the braking distance may become longer, the operation can be performed by the work device 400 at a position corresponding to the deviated stop position.

(G2d) In the embodiments from (G2) to (G2c), the generating unit 99 may not generate the value data when the acquired predicted value of braking distance is equal to or greater than a predetermined first reference distance. According to this form, in an environment where the actual stop position of the vehicle 100 may deviate relatively greatly from the expected stop position, the generation of the value data can be omitted, reducing the processing load associated with generating the value data. In such environment, it is preferable to handle the situation with a process different from generating value data, such as stopping the unmanned driving of each vehicle 100 or stopping the operation of each work device 400, and by omitting the generation of the value data, these different processes can be executed more smoothly. The first reference distance is determined based on an experiment as a distance large enough to prefer implementing the process different from generating value data. The experiment referred to here includes simulated experiment through simulation.

(G2e) In the embodiments from (G2) to (G2d), the notification unit 230 may notify the user when the predicted value of the acquired braking distance is equal to or greater than the predetermined second reference distance. The second reference distance may be the same as the first reference distance or may be different from the first reference distance. According to this form, the user can be notified of abnormalities in an environment where the actual stop position of the vehicle 100 may deviate significantly from the expected stop position.

(G3) In each of the above embodiments, the generating unit 99 may use, when the external environment is outdoors, a ranging device as the external sensor 300, acquire vehicle location information using three-dimensional point cloud information as the detection result, and generate the value data using environmental point cloud information as environmental information. The three-dimensional point cloud information acquired by the ranging device is generally less affected by ambient brightness compared to the imaging images acquired by the camera. Therefore, even if the brightness around the external sensor 300 changes due to time of day or weather, unmanned driving and value data generation can be executed more appropriately.

(G4) In each of the above embodiments, the generating unit 99 may use, when the external environment is indoors, a camera as the external sensor 300, acquire vehicle location information using an imaging image as the detection result, and generate value data using the imaging image as environmental information. According to this form, for example, compared to using a ranging device as the external sensor 300 when the external environment is indoors, the cost required to prepare the external sensor 300 can be reduced.

(G5) In each of the above embodiments, the vehicle 100 is configured to be able to run indoors and outdoors by unmanned driving, and the generating unit 99 may generate the value data only when the external environment is indoors. According to this form, the value data can be generated outdoors, where the external environment is relatively unstable compared to indoors, and the processing load associated with generating the value data can be reduced.

(G6) In each of the above embodiments, the acquisition unit 210 may function as a weather information acquisition unit that acquires weather information. In this case, the generating unit 99 may generate the value data when the acquired weather information meets a predetermined weather condition and may not generate the value data when the weather information does not meet the weather condition. The weather condition includes, for example, the occurrence of rain, snow, fog, or yellow sand, or the prediction of such occurrences. The weather information may be acquired from an external computer or recording medium, or from memory 112, 202, 312, or 412. According to this form, the value data can be generated to suppress deviation in stop position in case of bad weather or predicted bad weather, and the generation of the value data can be omitted to reduce the processing load associated with generating the value data when there is no bad weather or bad weather is not predicted.

(G7) In each of the above embodiments, the generating unit 99 may generate the value data when the preceding vehicle of the target vehicle 100 could not stop at the expected stop position, and may not generate the value data when the preceding vehicle could stop at the expected stop position. The preceding vehicle is the vehicle 100 that precedes the target vehicle 100. According to this form, the value data can be generated to suppress deviation in stop position in an environment where the actual stop position and the expected stop position may deviate following the preceding vehicle, and the generation of the value data can be omitted to reduce the processing load associated with generating the value data when the likelihood of deviation in stop position is low.

(G8) In each of the above embodiments, the apparatus may use the value data used for the target vehicle 100 for the subsequent vehicle of the target vehicle 100. According to this form, compared to generating value data individually for the subsequent vehicle in addition to the target vehicle 100, the processing load associated with generating value data can be reduced.

(G8a) In the above embodiment (G8), the apparatus may continuously use the same value data for the further subsequent vehicle 100 until a predetermined release condition is met. The release condition preferably includes at least one of the following: the weather has changed from rainy to clear; the user has performed an operation to stop the continuous use of value data; and the deviation between the actual stop position and the expected stop position when using value data has exceeded a predetermined degree. According to this form, the processing load associated with generating the value data can be further reduced. Furthermore, in situations where it is not preferable to continuously use the used value data for subsequent vehicles, the continuous use of the used value data can be stopped and new value data can be generated.

(G9) In each of the above embodiments, unmanned driving of the vehicle 100 may be stopped when the acquired environmental information meets a predetermined first condition. The first condition may include a condition related to at least one of the feature of the environmental image and the feature of the environmental point cloud information. More specifically, the first condition may include at least one of the following: the brightness in the environmental image is below a predetermined reference brightness; the proportion of the environmental image occupied by the predetermined object is above a reference proportion; the number of points in the environmental point cloud information is below a reference number of points; the point cloud density in the environmental point cloud information is below a reference point cloud density; and the detection distance in the environmental point cloud information is below a reference distance. According to this form, unmanned driving can be stopped in an environment where it is not preferable to execute unmanned driving. If the environmental information meets the first condition, the generating unit 99 may not generate the value data. In this way, the processing load associated with generating the value data can be reduced.

(G10) In each of the above embodiments, a travel route of the vehicle 100 may be changed when the acquired environmental information meets a predetermined second condition. In this case, for example, at least a part of the travel route of the vehicle 100 may be changed from a route traveling outdoors to a route traveling indoors when the environmental information meets the second condition. The second condition may include conditions related to at least one of the feature of the environmental image and the feature of the environmental point cloud information, similar to the first condition. According to this form, it is possible to change the travel route of the vehicle 100 to avoid an environment where the actual stop position and the expected stop position may significantly deviate. If the environmental information meets the second condition, the generating unit 99 may not generate the value data. Both the processing of the above embodiment (G9) and the processing of this embodiment (G10) may be applied together. In this case, the second condition may be less strict than the first condition. In this way, for example, unmanned driving can be stopped only in an environment where both the generation of the value data and the change of the travel route are not preferable, thereby achieving both efficient movement and appropriate control of the vehicle 100 by unmanned driving.

(G11) In each of the above embodiments, the remote control unit 220 or the vehicle control unit 115 may generate control commands to change the inter-vehicle distance between the target vehicle 100 and the preceding vehicle, and the inter-vehicle distance between the target vehicle 100 and the subsequent vehicle, using the environmental information. According to this form, excessive proximity or excessive separation between vehicles 100 due to the external environment can be suppressed, allowing each vehicle 100 to travel more appropriately.

(G11a) In the above embodiment (G11), the remote control unit 220 or the vehicle control unit 115 may increase the inter-vehicle distance when the brightness of the environmental image is the first brightness compared to when the brightness is the second brightness. The remote control unit 220 or the vehicle control unit 115 may increase the inter-vehicle distance when the environmental image contains the predetermined object compared to when the environmental image does not contain the object. The remote control unit 220 or the vehicle control unit 115 may increase the inter-vehicle distance when the proportion of the environmental image occupied the predetermined object is the first proportion compared to when it is the second proportion. According to this form, excessive proximity between vehicles 100 due to deterioration of road conditions or decreased accuracy of the vehicle location information caused by bad weather can be suppressed.

(G11b) In the embodiment (G11), the remote control unit 220 or the vehicle control unit 115 may increase the inter-vehicle distance when the number of points in the environmental point cloud information is the first number of points compared to when it is the second number of points. The remote control unit 220 or the vehicle control unit 115 may increase the inter-vehicle distance when the point cloud density in the environmental point cloud information is the first point cloud density compared to when it is the second point cloud density. The remote control unit 220 or the vehicle control unit 115 may increase the inter-vehicle distance when the detection distance in the environmental point cloud information is the first detection distance compared to when it is the second detection distance. According to this form, excessive proximity between vehicles 100 due to deterioration of road conditions or decreased accuracy of the vehicle location information caused by bad weather can be suppressed.

(G12) In each of the above embodiments, the generating unit 99 may generate both braking-related values and work-related values as value data. The value data may include the work setting value as the work-related value. The work-related values may not be parameters related to the position or movement of the arm unit 420 of the work device 400. For example, if the work device 400 includes a moving unit for moving the work device 400, the work-related values may be parameters related to the position of the work device 400 or parameters related to the movement of the moving unit.

(G13) In each of the above embodiments, the braking-related value is generated as a value to adjust the stop position of the vehicle 100 to a position on the rear side in the travel direction. Conversely, the braking-related value may be generated as a value to adjust the stop position of the vehicle 100 to a position on the front side in the travel direction. For example, the generating unit 99 may use the environmental information to detect an element that prompts braking of the vehicle 100, and when such element is detected, generate a braking-related value to adjust the stop position of the vehicle 100 to a position on the front side in the travel direction. The element that prompts braking of the vehicle 100 includes, for example, increase in surface irregularities due to road degradation or a foreign object such as a sheet or tape that can increase friction between the road surface and the wheels. Similarly, the work-related value may not be a value to adjust the work position to a position on the front side in the travel direction.

(G14) In each of the above embodiments, the system 50 may not be equipped with a sensor identification unit 215. In this case, after environmental information is acquired from multiple external sensors 300 without identifying the external sensor 300, the environmental information used for generating value data may be selected. In this case, the environmental information used for generating value data may be selected using a method similar to that used by the sensor identification unit 215 to identify the target external sensor 300.

(G15) In each of the above embodiments, the control command may include at least one of the running control signal and the generation information for generating the running control signal. For example, when the remote control unit 220 of the server 200 generates generation information as a control command, the vehicle controller 110 of the vehicle 100 may receive the generation information from the server 200 and generate the running control signal using the received generation information. As generation information, for example, vehicle location information, a route, or a target location may be used.

(G16) In the above-described first embodiment, the server 200 performs the processing from acquisition of vehicle location information to generation of a running control signal. By contrast, the vehicle 100 may perform at least part of the processing from acquisition of vehicle location information to generation of a running control signal. For example, embodiments (1) to (3) described below are applicable, for example.

(1) The server 200 may acquire vehicle location information, determine a target location to which the vehicle 100 is to move next, and generate a route from a current location of the vehicle 100 indicated by the acquired vehicle location information to the target location. The server 200 may generate a route to the target location between the current location and a destination or generate a route to the destination. The server 200 may transmit the generated route to the vehicle 100. The vehicle 100 may generate a running control signal in such a manner as to cause the vehicle 100 to run along the route received from the server 200 and control the actuator group 120 using the generated running control signal.

(2) The server 200 may acquire vehicle location information and transmit the acquired vehicle location information to the vehicle 100. The vehicle 100 may determine a target location to which the vehicle 100 is to move next, generate a route from a current location of the vehicle 100 indicated by the received vehicle location information to the target location, generate a running control signal in such a manner as to cause the vehicle 100 to run along the generated route, and control the actuator group 120 using the generated running control signal.

(3) In the foregoing embodiments (1) and (2), an internal sensor may be mounted on the vehicle 100, and detection result output from the internal sensor may be used in at least one of the generation of the route and the generation of the running control signal. The internal sensor is a sensor mounted on the vehicle 100. The internal sensor may include, for example, sensor that detects the motion state of the vehicle 100, the operating state of each part of the vehicle 100, and the environment around the vehicle 100. Specifically, the internal sensor may include a camera, LiDAR, a millimeter wave radar, an ultrasonic wave sensor, a GPS sensor, an acceleration sensor, and a gyroscopic sensor, for example. For example, in the foregoing embodiment (1), the server 200 may acquire detection result from the internal sensor, and in generating the route, may reflect the detection result from the internal sensor in the route. In the foregoing embodiment (1), the vehicle 100 may acquire detection result from the internal sensor, and in generating the running control signal, may reflect the detection result from the internal sensor in the running control signal. In the foregoing embodiment (2), the vehicle 100 may acquire detection result from the internal sensor, and in generating the route, may reflect the detection result from the internal sensor in the route. In the foregoing embodiment (2), the vehicle 100 may acquire detection result from the internal sensor, and in generating the running control signal, may reflect the detection result from the internal sensor in the running control signal.

(G17) In the above-described sixth embodiment, the vehicle 100 may be equipped with an internal sensor, and detection result output from the internal sensor may be used in at least one of generation of a route and generation of a running control signal. For example, the vehicle 100 may acquire detection result from the internal sensor, and in generating the route, may reflect the detection result from the internal sensor in the route. The vehicle 100 may acquire detection result from the internal sensor, and in generating the running control signal, may reflect the detection result from the internal sensor in the running control signal.

(G18) In the above-described sixth embodiment, the vehicle 100 acquires vehicle location information using detection result from the external sensor. By contrast, the vehicle 100 may be equipped with an internal sensor, the vehicle 100 may acquire vehicle location information using detection result from the internal sensor, determine a target location to which the vehicle 100 is to move next, generate a route from a current location of the vehicle 100 indicated by the acquired vehicle location information to the target location, generate a running control signal for running along the generated route, and control the actuator group 120 using the generated running control signal. In this case, the vehicle 100 is capable of running without using any detection result from an external sensor. The vehicle 100 may acquire target arrival time or traffic congestion information from outside the vehicle 100 and reflect the target arrival time or traffic congestion information in at least one of the route and the running control signal. The functional configuration of the system 50v may be entirely provided at the vehicle 100. Specifically, the processes realized by the system 50v in the present disclosure may be realized by the vehicle 100 alone.

(G19) In the above-described embodiments from first embodiment to fifth embodiment, the server 200 automatically generates a running control signal to be transmitted to the vehicle 100. By contrast, the server 200 may generate a running control signal to be transmitted to the vehicle 100 in response to operation by an external operator existing outside the vehicle 100. For example, the external operator may operate an operating device including a display on which a captured image output from the external sensor 300 is displayed, steering, an accelerator pedal, and a brake pedal for operating the vehicle 100 remotely, and a communication device for making communication with the server 200 through wire communication or wireless communication, for example, and the server 200 may generate a running control signal responsive to the operation on the operating device. Hereinafter, unmanned driving realized in response to the operation of the control device by such an external operator is also referred to as remote manual operation.

(G19a) In the above embodiment (G19), the generating unit 99 may generate a braking correction value to correct the braking control value generated in response to the operation of the control device using the environmental information.

(G20) In each of the above embodiments, the remote manual operation may be executed when the acquired environmental information meets a predetermined third condition. The third condition may be, for example, similar to the first condition, a condition related to at least one of the feature of the captured image of the external environment and the feature of the 3D point cloud information capturing the external environment. According to this form, in an environment where the actual stop position and the assumed stop position can deviate relatively significantly, the vehicle 100 can be appropriately driven by remote manual operation. If the environmental information meets the third condition, the generating unit 99 may not generate the value data. Furthermore, both the processing of the above form (G9) and the processing of this form (G20) may be applied. In this case, the third condition may be a looser condition than the first condition. In this way, for example, unmanned driving is only stopped in an environment where both the generation of value data and remote manual operation are undesirable, allowing for both efficient movement of the vehicle 100 by unmanned driving and appropriate control of the vehicle 100 by unmanned driving. Furthermore, both the processing of the above form (G10) and the processing of this form (G20) may be applied.

(G21) In each of the above-described embodiments, the vehicle 100 is simply required to have a configuration to become movable by unmanned driving. The vehicle 100 may embodied as a platform having the following configuration, for example. The vehicle 100 is simply required to include at least the vehicle controller 110 and the actuator group 120 in order to fulfill three functions including “run,” “turn,” and “stop” by unmanned driving. In order for the vehicle 100 to acquire information from outside for unmanned driving, the vehicle 100 is simply required to include the communication device 130 further. Specifically, the vehicle 100 to become movable by unmanned driving is not required to be equipped with at least some of interior components such as a driver's seat and a dashboard, is not required to be equipped with at least some of exterior components such as a bumper and a fender or is not required to be equipped with a bodyshell. In such cases, a remaining component such as a bodyshell may be mounted on the vehicle 100 before the vehicle 100 is shipped from the factory FC, or a remaining component such as a bodyshell may be mounted on the vehicle 100 after the vehicle 100 is shipped from the factory FC while the remaining component such as a bodyshell is not mounted on the vehicle 100. Each of components may be mounted on the vehicle 100 from any direction such as from above, from below, from the front, from the back, from the right, or from the left. Alternatively, these components may be mounted from the same direction or from respective different directions. The location determination for the platform may be performed in the same way as for the vehicle 100 in the first embodiments.

(G22) The vehicle 100 may be manufactured by combining a plurality of modules. The module means a unit composed of one or more components grouped according to a configuration or function of the vehicle 100. For example, a platform of the vehicle 100 may be manufactured by combining a front module, a center module and a rear module. The front module constitutes a front part of the platform, the center module constitutes a center part of the platform, and the rear module constitutes a rear part of the platform. The number of the modules constituting the platform is not limited to three but may be equal to or less than two, or equal to or greater than four. In addition to or instead of the platform, any parts of the vehicle 100 different from the platform may be modularized. Various modules may include an arbitrary exterior component such as a bumper or a grill, or an arbitrary interior component such as a seat or a console. Not only the vehicle 100 but also any types of moving object may be manufactured by combining a plurality of modules. Such a module may be manufactured by joining a plurality of components by welding or using a fixture, for example, or may be manufactured by forming at least part of the module integrally as a single component by casting. A process of forming at least part of a module as a single component is also called Giga-casting or Mega-casting. Giga-casting can form each part conventionally formed by joining multiple parts in a moving object as a single component. The front module, the center module, or the rear module described above may be manufactured using Giga-casting, for example.

(G23) A configuration for realizing running of a vehicle by unmanned driving is also called a “Remote Control auto Driving system”. Conveying a vehicle using Remote Control Auto Driving system is also called “self-running conveyance”. Producing the vehicle using self-running conveyance is also called “self-running production”. In self-running production, for example, at least part of the conveyance of vehicles is realized by self-running conveyance in a factory where the vehicle is manufactured.

(G24) In each of the embodiments described above, some or all of the functions and processes that are implemented by software may also be implemented by hardware. Further, some or all of the functions and processes that are implemented by hardware may also be implemented by software. Examples of the hardware used to implement various functions in each of the embodiments described above include various circuits, such as integrated circuits and discrete circuits.

The disclosure is not limited to any of the embodiment and its modifications described above but may be implemented by a diversity of configurations without departing from the scope of the disclosure. For example, the technical features of any of the above embodiments and their modifications corresponding to the technical features of each of the aspects described in SUMMARY may be replaced or combined appropriately, in order to solve part or all of the problems described above or in order to achieve part or all of the advantageous effects described above. Any of the technical features may be omitted appropriately unless the technical feature is described as essential in the description hereof.

What is claimed is:

1. An apparatus comprising:
an acquiring unit configured to acquire environmental information regarding at least one of environment around a current location of a moving object, and environment ahead of the moving object in a travel direction, the moving object being capable of moving by unmanned driving; and
a generating unit configured to generate value data using the acquired environmental information, the value data including at least one of a braking control value, a braking correction value, a work control value, a work setting value, and a work correction value, the braking control value being a control value regarding braking of the moving object, the braking correction value being a correction value to correct the braking control value, the work control value being a control value for controlling a work device performing an operation on the moving object, the work setting value being a setting value of the work device, the work correction value being a correction value to correct the work control value.

2. The apparatus according to claim 1, wherein
the environmental information includes an image in which the environment ahead of the moving object is captured.

3. The apparatus according to claim 2, wherein
the generating unit acquires, from the image, a feature regarding at least one of brightness of the image, presence or absence of a predetermined object in the image, and a proportion of the image occupied by the predetermined object, and
the generating unit generates the value data using the acquired at least one feature.

4. The apparatus according to claim 1, wherein
the environmental information includes three-dimensional point cloud information of the environment ahead of the moving object.

5. The apparatus according to claim 4, wherein
the generating unit acquires, from the three-dimensional point cloud information, a feature regarding at least one of a number of points in a point cloud, density of the point cloud, and detection distance of the point cloud, and
the generating unit generates the value data using the acquired at least one feature.
